(19) United States
(12) Patent Application Publication
(10) Pub. No.: US 2016/0349643 A1
(43) Pub. Date: Dec. 1, 2016

(54) ELECTROSTATIC-IMAGE DEVELOPING TONER, ELECTROSTATIC-IMAGE DEVELOPER, AND TONER CARTRIDGE

(71) Applicant: FUJI XEROX CO., LTD., Tokyo (JP)

(72) Inventors: Erina SAITO, Kanagawa (JP); Kotaro YOSHIHARA, Kanagawa (JP); Daisuke ISHIZUKA, Kanagawa (JP); Yuka KAWAMOTO, Kanagawa (JP)

(73) Assignee: FUJI XEROX CO., LTD., Tokyo (JP)

(21) Appl. No.: 14/938,949

(22) Filed: Nov. 12, 2015

(30) Foreign Application Priority Data
May 26, 2015 (JP) 2015-106750

(51) Int. Cl. G03G 9/00

(52) U.S. Cl. CPC G03G 9/08755

(57) ABSTRACT

An electrostatic-image developing toner includes a toner particle that includes a binder resin including an amorphous polyester resin and a crystalline polyester resin and that includes a styrene-alkyl(meth)acrylate copolymer. The glass transition temperature Tg(A) of the styrene-alkyl(meth)acrylate copolymer and the glass transition temperature Tg(B) of the amorphous polyester resin satisfy Relational expression (1): Tg(B)−10≦Tg(A)≦Tg(B)+2.5.

### CROSS-REFERENCE TO RELATED APPLICATIONS

This application is based on and claims priority under 35 USC 119 from Japanese Patent Application No. 2015-106750 filed May 26, 2015.

### BACKGROUND

### Technical Field

The present invention relates to an electrostatic-image developing toner, an electrostatic-image developer, and a toner cartridge.

### SUMMARY

According to an aspect of the invention, there is provided an electrostatic-image developing toner including a toner particle that includes a binder resin including an amorphous polyester resin and a crystalline polyester resin and that includes a styrene-alkyl(meth)acrylate copolymer. The glass transition temperature Tg(A) of the styrene-alkyl(meth)acrylate copolymer and the glass transition temperature Tg(B) of the amorphous polyester resin satisfy Relational expression (1).

Tg(B)−10≦Tg(A)≦Tg(B)+2.5 (1)

### BRIEF DESCRIPTION OF THE DRAWINGS

Exemplary embodiments of the present invention will be described in detail based on the following figures, wherein:

FIG. 1 schematically illustrates an example of an image forming apparatus according to an exemplary embodiment; and

FIG. 2 schematically illustrates an example of a process cartridge according to an exemplary embodiment.

### DETAILED DESCRIPTION

Exemplary embodiments of the present invention are described below.

### Electrostatic-Image Developing Toner

The electrostatic-image developing toner according to an exemplary embodiment (hereinafter, referred to as “toner”) includes toner particles that include a binder resin including an amorphous polyester resin and a crystalline polyester resin and that include a styrene-alkyl(meth)acrylate copolymer. The glass transition temperature Tg(A) of the styrene-alkyl(meth)acrylate copolymer and the glass transition temperature Tg(B) of the amorphous polyester resin satisfy Relational expression (1).

Tg(B)−10≦Tg(A)≦Tg(B)+2.5 (1)

The above-described toner according to the exemplary embodiment may reduce the likelihood of image loss due to document offset which may occur when films (i.e., recording media) having low-temperature fixability and containing images formed thereon are stacked on one another. The reason for this is not clearly understood but is probably due to the following reason.

With the recent advances in technology for fixing toners at low temperatures, it has become possible to form images at lower temperatures. However, low-temperature fixability is inconsistent with resistance to document offset. Taking films containing images formed thereon for instance, when the films containing images are stacked on one another, a pressure is applied to the images formed on the films since the surfaces of the films have a high degree of smoothness, which may cause document offset to occur. If document offset occurs, image loss may occur due to the document offset. It has been found that this phenomenon is particularly substantial when images are formed and stacked on one another under a high-temperature, high-humidity condition (e.g., temperature: 30° C., humidity: 85 RH %) and is likely to occur when images are formed on films made of polyester materials, such as overhead projector (OHP) films. This tendency becomes more substantial when a toner having low-temperature fixability is used.

It is possible to impart low-temperature fixability to a toner by, for example, adding an amorphous polyester resin and a crystalline polyester resin to toner particles. It has been found that, when a toner produced by this technique is used, the likelihood of image loss due to the above-described document offset may be increased.

Films such as OHP films are generally heavier and have better surface smoothness than paper. When films containing images formed thereon are stacked on one another, a high load is applied to the images formed on the films compared with the case where sheets of paper containing images formed thereon are stacked on one another. Accordingly, the pressure applied to the images formed on the films may be increased. The increased pressure may cause some resin components derived from a toner contained in the images to migrate onto the surfaces of the films, which presumably causes document offset to occur. When a film in which document offset has occurred is removed from the adjacent film, the image may be destroyed and, as a result, part of the image formed on the film may be lost.

In general, low-molecular-weight components included in the resin components, which are capable of easily migrating, are considered to serve as a plasticizer. It is considered that low-molecular-weight components (hereinafter, also referred to as “specific low-molecular-weight components”) having a molecular weight of 1,000 or more and 2,000 or less, which are included in the resin components of the toner, contribute to the image loss due to document offset. The specific low-molecular-weight components included in the resin components of the toner are considered to be mainly derived from the polyester resin included in the toner particles.

When films containing images formed thereon are stacked on one another, a pressure is applied to the images, which causes the specific low-molecular-weight components included in the resin components of the toner contained in the images to migrate onto the surface of the films on which the images are formed. Consequently, a portion of the film on which the image is formed may be plasticized and the likelihood of document offset may be increased, which presumably causes image loss to occur.

In order to address the above-described issue, the toner according to the exemplary embodiment includes toner particles each including a styrene-alkyl(meth)acrylate copolymer having a glass transition temperature satisfying a specific condition (i.e., Tg(B)−10≦Tg(A)≦Tg(B)+2.5 . . . (1), where Tg(A) represents the glass transition temperature of the styrene-alkyl(meth)acrylate copolymer and Tg(B) represents the glass transition temperature of the amorphous polyester resin).

In toner particles including the styrene-alkyl(meth)acrylate copolymer satisfying the above condition, the styrene-alkyl(meth)acrylate copolymer is likely to be present on the surfaces of the toner particles. This reduces the likelihood of the specific low-molecular-weight components, which are considered to be derived from the polyester resin included in the toner particles, migrating onto the surfaces of the toner particles. As a result, migration of the specific low-molecular-weight components onto the surface of the film may be suppressed. This reduces the likelihood of the film being plasticized due to the specific low-molecular-weight components, which presumably reduces the occurrence of document offset. Adding the styrene-alkyl(meth)acrylate copolymer satisfying the above relational expression to the toner particles may also increase the irregularities of the surface of the image formed on the film. When irregularities are present in the surface of the image, the number of the points at which the image formed on the film is brought into contact with the adjacent film is reduced and consequently the occurrence of document offset may be reduced, which presumably reduces the likelihood of the image formed on the film being detached. As a result, the occurrence of image loss due to document offset may be reduced.

Thus, it is considered that the toner according to the exemplary embodiment may reduce, even in the case where images are formed on films, the occurrence of image loss due to document offset which may occur when films (i.e., recording media) having low-temperature fixability and containing images formed thereon are stacked on top of one another.

The term “film” used herein refers to both a material commonly referred to as “film” and a material commonly referred to as “sheet”.

The toner according to the exemplary embodiment is described in detail below.

The toner according to the exemplary embodiment includes toner particles and, as needed, a surface additive.

### Toner Particles

The toner particles include, for example, a binder resin and, as needed, a colorant, a release agent, and other additives.

Binder Resin

The binder resin may be a polyester resin.

Examples of the polyester resin include amorphous polyester resins known in the related art. A crystalline polyester resin may be used as a polyester resin in combination with an amorphous polyester resin. In such a case, the content of the crystalline polyester resin in the binder resin may be set to 2% by mass or more and 40% by mass or less and is preferably set to 2% by mass or more and 20% by mass or less.

The term “crystalline” resin used herein refers to a resin that, in thermal analysis using differential scanning calorimetry (DSC), exhibits a distinct endothermic peak instead of step-like endothermic change and specifically refers to a resin that exhibits an endothermic peak with a half-width of 10° C. or less at a heating rate of 10 ° C./min.

On the other hand, the term “amorphous” resin used herein refers to a resin that exhibits an endothermic peak with a half-width of more than 10° C., that exhibits step-like endothermic change, or that does not exhibit a distinct endothermic peak.

Amorphous Polyester Resin

Examples of the amorphous polyester resin include condensation polymers of a polyvalent carboxylic acid and a polyhydric alcohol. The amorphous polyester resin may be a commercially available one or a synthesized one.

Examples of the polyvalent carboxylic acid include aliphatic dicarboxylic acids (e.g., oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides of these dicarboxylic acids, and lower (e.g., 1 to 5 carbon atoms) alkyl esters of these dicarboxylic acids. Among these dicarboxylic acids, for example, aromatic dicarboxylic acids may be used as a polyvalent carboxylic acid.

Trivalent or higher multivalent carboxylic acids having a crosslinked structure or a branched structure may be used as a polyvalent carboxylic acid in combination with the dicarboxylic acids. Examples of the trivalent or higher multivalent carboxylic acids include trimellitic acid, pyromellitic acid, anhydrides of these carboxylic acids, and lower (e.g., 1 to 5 carbon atoms) alkyl esters of these carboxylic acids.

The above-described polyvalent carboxylic acids may be used alone or in combination of two or more.

Examples of the polyhydric alcohol include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., bisphenol A-ethylene oxide adduct and bisphenol A-propylene oxide adduct). Among these diols, for example, aromatic diols and alicyclic diols may be used as a polyhydric alcohol. In particular, aromatic diols may be used as a polyhydric alcohol.

Trihydric or higher polyhydric alcohols having a crosslinked structure or a branched structure may be used as a polyhydric alcohol in combination with the diols. Examples of the trihydric or higher polyhydric alcohols include glycerin, trimethylolpropane, and pentaerythritol.

The above-described polyhydric alcohols may be used alone or in combination of two or more.

The glass transition temperature Tg(B) of the amorphous polyester resin is preferably 50° C. or more and 80° C. or less and is more preferably 50° C. or more and 65° C. or less.

The glass transition temperature is determined from a DSC curve obtained by differential scanning calorimetry (DSC). More specifically, the glass transition temperature is determined from the “extrapolated glass-transition-starting temperature” according to a method for determining glass transition temperature which is described in JIS K 7121-1987 “Testing Methods for Transition Temperatures of Plastics”.

The weight-average molecular weight Mw of the amorphous polyester resin is preferably 5,000 or more and 1,000,000 or less and is more preferably 7,000 or more and 500,000 or less.

The number-average molecular weight Mn of the amorphous polyester resin is preferably 2,000 or more and 100,000 or less.

The molecular weight distribution index Mw/Mn of the amorphous polyester resin is preferably 1.5 or more and 100 or less and is more preferably 2 or more and 60 or less.

The weight-average molecular weight and number-average molecular weight of the amorphous polyester resin are determined by gel permeation chromatography (GPC). Specifically, the molecular weights of the amorphous polyester resin are determined by GPC using a “HLC-8120GPC” produced by Tosoh Corporation as measuring equipment, a column “TSKgel SuperHM-M (15 cm)” produced by Tosoh Corporation, and a tetrahydrofuran (THF) solvent. The weight-average molecular weight and number-average molecular weight of the amorphous polyester resin are determined on the basis of the results of the measurement using a molecular-weight calibration curve based on monodisperse polystyrene standard samples.

The amorphous polyester resin may be produced by any suitable production method known in the related art. Specifically, the amorphous polyester resin may be produced by, for example, a method in which polymerization is performed at 180° C. or more and 230° C. or less and the pressure inside the reaction system is reduced as needed while water and alcohols that are generated by condensation are removed.

In the case where the raw materials, that is, the monomers, are not dissolved in or compatible with each other at the reaction temperature, a solvent having a high boiling point may be used as a dissolution adjuvant in order to dissolve the raw materials. In such a case, the condensation polymerization reaction is performed while the dissolution adjuvant is distilled away. In the case where monomers used for copolymerization have low compatibility with each other, a condensation reaction of the monomers with an acid or alcohol that is to undergo a polycondensation reaction with the monomers may be performed in advance and subsequently a polycondensation of the resulting polymers with the main components may be performed.

Crystalline Polyester Resin

Examples of the crystalline polyester resin include condensation polymers of a polyvalent carboxylic acid and a polyhydric alcohol. The crystalline polyester resin may be commercially available one or a synthesized one.

A condensation polymer prepared from polymerizable monomers including linear aliphatic monomers may be used as a crystalline polyester resin instead of a condensation polymer prepared from polymerizable monomers including aromatic monomers in order to increase ease of forming a crystal structure.

Examples of the polyvalent carboxylic acid include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids such as phthalic acid, isophthalic acid, terephthalic acid, and naphthalene-2,6-dicarboxylic acid), anhydrides of these dicarboxylic acids, and lower (e.g., 1 to 5 carbon atoms) alkyl esters of these dicarboxylic acids.

Trivalent or higher polyvalent carboxylic acids having a crosslinked structure or a branched structure may be used as a polyvalent carboxylic acid in combination with the dicarboxylic acids. Examples of the trivalent carboxylic acids include aromatic carboxylic acids (e.g., 1,2,3-benzenetricarboxylic acid, 1,2,4-benzenetricarboxylic acid, and 1,2,4-naphthalenetricarboxylic acid), anhydrides of these tricarboxylic acids, and lower (e.g., 1 to 5 carbon atoms) alkyl esters of these tricarboxylic acids.

Dicarboxylic acids including a sulfonic group and dicarboxylic acids including an ethylenic double bond may be used as a polyvalent carboxylic acid in combination with the above dicarboxylic acids.

The above-described polyvalent carboxylic acids may be used alone or in combination of two or more.

Examples of the polyhydric alcohol include aliphatic diols (e.g., linear aliphatic diols including a main chain having 7 to 20 carbon atoms). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these aliphatic diols, 1,8-octanediol, 1,9-nonanediol, and 1,10-decanediol may be used.

Trihydric or higher polyhydric alcohols having a crosslinked structure or a branched structure may be used as a polyhydric alcohol in combination with the above diols. Examples of the trihydric or higher polyhydric alcohols include glycerin, trimethylolethane, trimethylolpropane, and pentaerythritol.

The above-described polyhydric alcohols may be used alone or in combination of two or more.

The content of the aliphatic diols in the polyhydric alcohol may be 80 mol % or more and is preferably 90 mol % or more.

The above-described crystalline polyester resin may be a condensation polymer of, for example, a saturated-aliphatic-polyvalent-carboxylic-acid component including a saturated aliphatic dicarboxylic acid (examples thereof include anhydrides thereof and lower [e.g., 1 to 5 carbon atoms] alkyl esters thereof) and a saturated-aliphatic-polyhydric-alcohol component including a saturated aliphatic diol in order to further enhance low-temperature fixability.

The crystalline polyester resin may include at least one monomer component selected from a saturated aliphatic polyvalent carboxylic acid (e.g., saturated aliphatic dicarboxylic acid) including an alkylene group having 6 to 14 carbon atoms (preferably having 6 to 12 carbon atoms and more preferably having 6 to 10 carbon atoms) and a saturated aliphatic polyhydric alcohol (e.g., saturated aliphatic diol) including an alkylene group having 6 to 14 carbon atoms (preferably having 6 to 12 carbon atoms and more preferably having 6 to 10 carbon atoms) such that the content of the saturated aliphatic polyvalent carboxylic acid and the saturated aliphatic polyhydric alcohol in all monomer components of the crystalline polyester resin is 30% by mass or more (more preferably 30% by mass or more and 50% by mass or less and further preferably 40% by mass or more and 50% by mass or less) in order to further reduce the likelihood of image loss due to document offset which may occur when films (i.e., recording media) having low-temperature fixability and containing images formed thereon are stacked on one another.

Using such a crystalline polyester resin increases, for example, ease of controlling the content of the specific low-molecular-weight components having a molecular weight of 1,000 or more and 2,000 or less in resin components of the toner to be 8% or less.

The melting temperature of the crystalline polyester resin is preferably 50° C. or more and 100° C. or less, is more preferably 55° C. or more and 90° C. or less, and is further preferably 60° C. or more and 85° C. or less.

The melting temperature of the crystalline polyester resin is determined from the “melting peak temperature” according to a method for determining melting temperature which is described in JIS K 7121-1987 “Testing Methods for Transition Temperatures of Plastics” using a DSC curve obtained by differential scanning calorimetry (DSC).

The crystalline polyester resin may have a weight-average molecular weight Mw of 6,000 or more and 35,000 or less.

The crystalline polyester resin may be produced by any suitable method known in the related art similarly to the amorphous polyester resin.

The content of the binder resin in the toner particles is, for example, preferably 40% by mass or more and 95% by mass or less, is more preferably 50% by mass or more and 90% by mass or less, and is further preferably 60% by mass or more and 85% by mass or less.

Styrene-Alkyl(Meth)Acrylate Copolymer

The styrene-alkyl(meth)acrylate copolymer is, for example, a copolymer produced by copolymerization of at least a styrene-based monomer (i.e., monomer including a styrene skeleton) and a (meth)acrylate-based monomer (i.e., monomer including a (meth)acryloyl group). The styrene-alkyl(meth)acrylate copolymer may be a copolymer produced by copolymerization of the styrene-based monomer and the (meth)acrylate-based monomer with other monomers. Examples of the (meth)acrylate-based monomer include (meth)acrylic acid.

Note that the term “(meth)acrylate” used herein refers to both “acrylate” and “methacrylate”.

Specific examples of the styrene-based monomer include styrene; vinylnaphthalene; alkyl-substituted styrenes such as α-methylstyrene, o-methylstyrene, m-methylstyrene, p-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene; aryl-substituted styrenes such as p-phenylstyrene; alkoxy-substituted styrenes such as p-methoxystyrene; halogen-substituted styrenes such as p-chlorostyrene, 3,4-dichlorostyrene, 4-fluorostyrene, and 2,5-difluorostyrene; and nitro-substituted styrenes such as m-nitrostyrene, o-nitrostyrene, and p-nitrostyrene.

Among these styrene-based monomers, styrene, p-ethylstyrene, and p-n-butylstyrene may be used.

The styrene-based monomers may be used alone or in combination of two or more.

Specific examples of the (meth)acrylate-based monomer include (meth)acrylic acid; alkyl (meth)acrylates such as n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth) acrylate, n-tetradecyl (meth) acrylate, n-hexadecyl (meth) acrylate, n-octadecyl (meth) acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, octyl (meth)acrylate, decyl (meth)acrylate, lauryl (meth)acrylate, stearyl (meth)acrylate, cyclohexyl (meth)acrylate, dicyclopentanyl (meth)acrylate, and isobornyl (meth) acrylate;

di(meth)acrylates such as ethylene glycol di(meth)acrylate, diethylene glycol di(meth)acrylate, triethylene glycol di(meth)acrylate, butanediol di(meth)acrylate, pentanediol di(meth)acrylate, hexanediol di(meth)acrylate, nonanediol di(meth)acrylate, and decanediol di(meth)acrylate;

carboxy-substituted alkyl (meth)acrylates such as β-carboxyethyl (meth) acrylate;

hydroxy-substituted alkyl (meth)acrylates such as 2-hydroxyethyl (meth)acrylate, 2-hydroxypropyl (meth)acrylate, 3-hydroxypropyl (meth) acrylate, 2-hydroxybutyl (meth)acrylate, 3-hydroxybutyl (meth)acrylate, and 4-hydroxybutyl (meth)acrylate; and

alkoxy-substituted alkyl (meth)acrylates such as 2-methoxyethyl (meth) acrylate.

Among these (meth)acrylate-based monomers, alkyl (meth)acrylates including an alkyl group having 2 to 8 carbon atoms are more preferably used, and (meth)acrylates including an alkyl group having 4 to 8 carbon atoms are further preferably used in order to further reduce the likelihood of image loss which may occur, when resin films (i.e., recording media) having low-temperature fixability and containing images formed thereon are stacked on one another, due to transfer of portions of images formed on the resin films to the adjacent resin films.

The (meth)acrylate-based monomers may be used alone or in combination of two or more.

Examples of the other monomers include ethylenically unsaturated nitriles (e.g., acrylonitrile and methacrylonitrile), vinyl ethers (e.g., vinyl methyl ether and vinyl isobutyl ether), vinyl ketones (e.g., vinyl methyl ketone, vinyl ethyl ketone, and vinyl isopropenyl ketone), divinyls (e.g., divinyl adipate), and olefins (e.g., ethylene, propylene, and butadiene).

The proportion of the styrene-based monomer in all monomer components (i.e., proportion of the mass of repeating units derived from the styrene-based monomer in the entire mass of the copolymer) may be 60% by mass or more, is preferably 65% by mass or more and 90% by mass or less, and is more preferably 70% by mass or more and 85% by mass or less in order to further reduce the likelihood of image loss which may occur, when resin films (i.e., recording media) having low-temperature fixability and containing images formed thereon are stacked on one another, due to transfer of portions of images formed on the resin films to the adjacent resin films.

The proportion of the (meth)acrylate-based monomer in all monomer components (i.e., proportion of the mass of repeating units derived from the (meth)acrylate in the entire mass of the copolymer) may be 10% by mass or more and 40% by mass or less and is preferably 10% by mass or more and 35% by mass or less in order to further reduce the likelihood of image loss which may occur, when resin films (i.e., recording media) having low-temperature fixability and containing images formed thereon are stacked on one another, due to transfer of portions of images formed on the resin films to the adjacent resin films.

From the same point of view, in particular, the proportion of a (meth)acrylate including an alkyl group having 2 to 8 carbon atoms in all monomer components is preferably 20% by mass or more, is more preferably 20% by mass or more and 40% by mass or less, and is further preferably 20% by mass or more and 35% by mass or less.

The glass transition temperature Tg(A) of the styrene-alkyl(meth)acrylate copolymer and the glass transition temperature Tg(B) of the above-described amorphous polyester resin satisfy Relational expression (1) below, preferably satisfy Relational expression (2) below, and more preferably satisfy Relational expression (3).

Tg(B)−10≦Tg(A)≦Tg(B)+2.5 (1)

Tg(B)−6≦Tg(A)≦Tg(B)+2.0 (2)

Tg(B)−3≦Tg(A)≦Tg(B)+1.0 (3)

When Tg(A) and Tg(B) satisfy the above relational expression, the likelihood of image loss which may occur, when resin films (i.e., recording media) having low-temperature fixability and containing images formed thereon are stacked on one another, due to transfer of portions of images formed on the resin films to the adjacent resin films may be further reduced. Since softening of the styrene-alkyl(meth)acrylate copolymer occurs earlier than that of the amorphous polyester resin, the likelihood of a styrene-acrylic resin being present on the surfaces of the toner particles may be increased. The increase in the likelihood of the styrene-acrylic resin being present on the surfaces of the toner particles leads to a reduction of the likelihood of the above-described specific low-molecular-weight components migrating to the adjacent film. In addition, irregularities are formed in the surfaces of the images formed on the films, which may suppress detachment of the images.

The glass transition temperature Tg(A) of the styrene-alkyl(meth)acrylate copolymer is preferably 40° C. or more and 70° C. or less and is more preferably 50° C. or more and 65° C. or less in order to further reduce the likelihood of image loss which may occur, when resin films (i.e., recording media) having low-temperature fixability and containing images formed thereon are stacked on one another, due to transfer of portions of images formed on the resin films to the adjacent resin films.

The glass transition temperature Tg(A) of the styrene-alkyl(meth)acrylate copolymer is determined from a DSC curve obtained by differential scanning calorimetry (DSC). More specifically, the glass transition temperature is determined from the “extrapolated glass-transition-starting temperature” according to a method for determining glass transition temperature which is described in JIS K 7121-1987 “Testing Methods for Transition Temperatures of Plastics”.

The weight-average molecular weight Mw of the styrene-alkyl(meth)acrylate copolymer is preferably 4,000 or more and 100,000 or less, is more preferably 40,000 or more and 70,000 or less, and is further preferably 40,000 or more and 65,000 or less. The number-average molecular weight Mn of the styrene-alkyl(meth)acrylate copolymer is preferably 500 or more and 200,000 or less, is more preferably 1,000 or more and 30,000 or less, and is further preferably 5,000 or more and 20,000 or less. When the weight-average molecular weight Mw of the styrene-alkyl(meth)acrylate copolymer falls within the above-described range, ease of forming irregularities in the surfaces of the images formed on the films may be further increased.

The weight-average molecular weight and number-average molecular weight of the styrene-alkyl(meth)acrylate copolymer are determined by gel permeation chromatography (GPC). Specifically, the molecular weights of the styrene-alkyl(meth)acrylate copolymer are determined by GPC using a GPC “HLC-8120GPC” produced by Tosoh Corporation as measuring equipment, a column “TSKgel SuperHM-M (15 cm)” produced by Tosoh Corporation, and a tetrahydrofuran (THF) solvent. The weight-average molecular weight and number-average molecular weight of the styrene-alkyl(meth)acrylate copolymer are determined on the basis of the results of the measurement using a molecular-weight calibration curve based on monodisperse polystyrene standard samples.

The styrene-alkyl(meth)acrylate copolymer may be synthesized by any suitable polymerization method known in the related art (e.g., radical polymerization such as emulsion polymerization, soap-free emulsion polymerization, suspension polymerization, miniemulsion polymerization, or microemulsion polymerization).

The crosslinking density of the styrene-alkyl(meth)acrylate copolymer may be controlled by changing the amount of the crosslinking agent (e.g., decanediol di(meth)acrylate) used in the polymerization reaction.

In the production of the toner according to the exemplary embodiment, for example, the following styrene-alkyl(meth)acrylate copolymer and crystalline polyester resin may be used in combination in order to further reduce the likelihood of image loss which may occur, when resin films (i.e., recording media) having low-temperature fixability and containing images formed thereon are stacked on one another, due to transfer of portions of images formed on the resin films to the adjacent resin films:

a styrene-alkyl(meth)acrylate copolymer including an alkyl (meth)acrylate including an alkyl group having 2 to 8 carbon atoms (more preferably having 4 to 8 carbon atoms) such that the proportion of the alkyl (meth)acrylate in all monomer components is 20% by mass or more (preferably 20% by mass or more and 40% by mass or less and more preferably 20% by mass or more and 35% by mass or less); and

a crystalline polyester resin including at least one monomer component selected from a saturated aliphatic polyhydric alcohol including an alkylene group having 6 to 14 carbon atoms (preferably having 6 to 12 carbon atoms and more preferably having 6 to 10 carbon atoms) and a saturated aliphatic polyvalent carboxylic acid including an alkylene group having 6 to 14 carbon atoms (preferably having 6 to 12 carbon atoms and more preferably having 6 to 10 carbon atoms) such that the proportion of the selected monomer component in all monomer components is 30% by mass or more (preferably 30% by mass or more and 50% by mass or less and more preferably 40% by mass or more and 50% by mass or less).

The absolute value of the difference (i.e., Δcarbon number) between the number of carbon atoms included in the alkyl group of the alkyl (meth)acrylate and the number of carbon atoms included in the alkylene group of at least one monomer component selected from the saturated aliphatic polyhydric alcohol and the saturated aliphatic polyvalent carboxylic acid may be, for example, 0 to 12 (preferably 0 to 10 and more preferably 0 to 6) in order to further reduce the likelihood of image loss which may occur, when resin films (i.e., recording media) having low-temperature fixability and containing images formed thereon are stacked on one another, due to transfer of portions of images formed on the resin films to the adjacent resin films. When Δcarbon number is small, the affinity between the styrene-alkyl(meth)acrylate copolymer and the crystalline polyester resin is high, which further suppresses migration of the specific low-molecular-weight components to the film. As a result, the likelihood of image loss which may occur, when resin films (i.e., recording media) having low-temperature fixability and containing images formed thereon are stacked on one another, due to transfer of portions of images formed on the resin films to the adjacent resin films may be further reduced.

In the case where the crystalline polyester resin includes both saturated aliphatic polyhydric alcohol including 6 to 14 carbon atoms and the saturated aliphatic polyvalent carboxylic acid including 6 to 14 carbon atoms described above, the absolute value of the difference in the number of carbon atoms refers to the difference between the number of carbon atoms included in the alkyl group of the alkyl (meth)acrylate and the smaller of the numbers of carbon atoms included in the alkylene groups of the saturated aliphatic polyhydric alcohol and the saturated aliphatic polyvalent carboxylic acid.

The content of the styrene-alkyl(meth)acrylate copolymer in the toner particles may be, for example, 5% by mass or more and 30% by mass or less, is preferably 12% by mass or more and 28% by mass or less, and is more preferably 15% by mass or more and 25% by mass or less. Setting the content of the styrene-alkyl(meth)acrylate copolymer in the toner particles to be within the above range increases the compatibility of the styrene-alkyl(meth)acrylate copolymer with the specific low-molecular-weight components included in resin components of the toner, which further suppresses the migration of the specific low-molecular-weight components toward the film. As a result, the likelihood of image loss which may occur, when resin films (i.e., recording media) containing images formed thereon are stacked on one another, due to transfer of portions of images formed on the resin films to the adjacent resin films may be further reduced.

Colorant

Examples of the colorant include various pigments such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watching Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and various dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

The above colorants may be used alone or in combination of two or more.

The colorant may optionally be subjected to a surface treatment and may be used in combination with a dispersant. Plural types of colorants may be used in combination.

The content of the colorant in the toner particles is preferably, for example, 1% by mass or more and 30% by mass or less and is more preferably 3% by mass or more and 15% by mass or less.

Release Agent

Examples of the release agent include, but are not limited to, hydrocarbon waxes; natural waxes such as a carnauba wax, a rice bran wax, and a candelilla wax; synthetic or mineral-petroleum-derived waxes such as a montan wax; and ester waxes such as a fatty-acid ester wax and a montanate wax.

The melting temperature of the release agent is preferably 50° C. or more and 110° C. or less and is more preferably 60° C. or more and 100° C. or less.

The melting temperature of the release agent is determined from the “melting peak temperature” according to a method for determining melting temperature which is described in JIS K 7121-1987 “Testing Methods for Transition Temperatures of Plastics” using a DSC curve obtained by differential scanning calorimetry (DSC).

The content of the release agent in the toner particles is preferably, for example, 1% by mass or more and 20% by mass or less and is more preferably 5% by mass or more and 15% by mass or less.

Other Additives

Examples of the other additives include additives known in the related art, such as a magnetic substance, a charge-controlling agent, and an inorganic powder. These additives may be added to the toner particles as internal additives.

Properties, etc. of Toner Particles

The toner particles may have a single-layer structure or a “core-shell” structure constituted by a core (i.e., core particle) and a coating layer (i.e., shell layer) covering the core.

The core-shell structure of the toner particles may be constituted by, for example, a core including a binder resin and, as needed, other additives such as a colorant and a release agent and by a coating layer including the binder resin.

The volume-average diameter D50v of the toner particles is preferably 2 μm or more and 10 μm or less and is more preferably 4 μm or more and 8 μm or less.

The above-described average diameters and particle diameter distribution indices of the toner particles are measured using “COULTER Multisizer II” (produced by Beckman Coulter, Inc.) with an electrolyte “ISOTON-II” (produced by Beckman Coulter, Inc.) in the following manner.

A sample to be measured (0.5 mg or more and 50 mg or less) is added to 2 ml of a 5%-aqueous solution of a surfactant (e.g., sodium alkylbenzene sulfonate) that serves as a dispersant. The resulting mixture is added to 100 ml or more and 150 ml or less of an electrolyte.

The resulting electrolyte containing the sample suspended therein is subjected to a dispersion treatment for 1 minute using an ultrasonic disperser, and the distribution of the diameters of particles having a diameter of 2 μm or more and 60 μm or less is measured using COULTER Multisizer II with an aperture having a diameter of 100 μm. The number of the particles sampled is 50,000.

The particle diameter distribution measured is divided into a number of particle diameter ranges (i.e., channels). For each range, in ascending order in terms of particle diameter, the cumulative volume and the cumulative number are calculated and plotted to draw cumulative distribution curves. Particle diameters at which the cumulative volume and the cumulative number reach 16% are considered to be the volume particle diameter D16v and the number particle diameter D16p, respectively. Particle diameters at which the cumulative volume and the cumulative number reach 50% are considered to be the volume-average particle diameter D50v and the number-average particle diameter D50p, respectively. Particle diameters at which the cumulative volume and the cumulative number reach 84% are considered to be the volume particle diameter D84v and the number particle diameter D84p, respectively.

Using the volume particle diameters and number particle diameters measured, the volume-average particle diameter distribution index (GSDv) is calculated as (D84v/D16v)^{1/2} and the number-average particle diameter distribution index (GSDp) is calculated as (D84p/D16p)^{1/2}.

The shape factor SF1 of the toner particles is preferably 110 or more and 150 or less and is more preferably 120 or more and 140 or less.

The shape factor SF1 of the toner particles is determined using the following formula:

SF1=(ML²/A)×(π/4)×100

where ML represents the absolute maximum length of the toner particles and A represents the projected area of the toner particles.

Specifically, the shape factor SF1 of the toner particles is determined by analyzing a microscope image or scanning electron microscope (SEM) image of the toner particles using an image processor in the following manner. An optical microscope image of toner particles spread over the surface of a glass slide is loaded into a LUZEX image processor using a video camera. The maximum lengths and projected areas of 100 toner particles are measured. The shape factors SF1 of the 100 toner particles are calculated using the above formula, and the average of the shape factors SF1 is obtained.

In the toner according to the exemplary embodiment, the proportion of the specific low-molecular-weight components having a molecular weight of 1,000 or more and 2,000 or less in the molecular weight distribution of resin components of the toner which is obtained by gel permeation chromatography (GPC) may be 8% or less in order to further reduce the likelihood of image loss which may occur, when resin films (i.e., recording media) having low-temperature fixability and containing images formed thereon are stacked on one another, due to transfer of portions of images formed on the resin films to the adjacent resin films.

The content of the specific low-molecular-weight components in the molecular weight distribution of resin components of the toner which is obtained by GPC may be reduced to a minimum, is preferably 0% or more and 8% or less, is more preferably 0% or more and 5% or less, and is further preferably 0% or more and 3% or less in order to further reduce the likelihood of image loss which may occur, when resin films (i.e., recording media) containing images formed thereon are stacked on one another, due to transfer of portions of images formed on the resin films to the adjacent resin films.

Resin components having a molecular weight exceeding 2,000, which have high stability as resins, are considered to be less likely to contribute to the occurrence of document offset. Resin components (e.g., oligomers) having a molecular weight of less than 1,000 are considered to be less likely to contribute to the occurrence of document offset even when they migrate to the film.

The content of the specific low-molecular-weight components in the resin components of the toner may be controlled by, for example, changing monomer components of the polyester resin and controlling reaction conditions.

The molecular weight distribution of the toner is measured by dissolving a toner to be measured in tetrahydrofuran (THF) and measuring the dissolved components by gel permeation chromatography (GPC). Specifically, “HLC-8120GPC” and “SC-8020” (produced by Tosoh Corporation) are used as a GPC system with two columns “TSKgel SuperHM-H” (6.0 mmID×15 cm, produced by Tosoh Corporation). Tetrahydrofuran (THF) is used as an eluent. The measurement conditions are as follows: sample concentration: 0.5%, flow rate: 0.6 ml/min, sample injection volume: 10 μl, temperature: 40° C., and detector: refractive index (RI) detector. A calibration curve is prepared on the basis of the following ten samples: “Polystyrene standard sample TSK standard A-500, F-1, F-10, F-80, F-380, A-2500, F-4, F-40, F-128, and F-700” produced by Tosoh Corporation.

In the toner according to the exemplary embodiment, the proportion of the styrene-alkyl(meth)acrylate copolymer in resin components deposited on the surfaces of the toner particles is preferably 5 atom % or more and 25 atom % or less, is more preferably 5 atom % or more and 20 atom % or less, and is further preferably 5 atom % or more and 15 atom % or less as determined by X-ray photoelectron spectroscopy (XPS) in order to further reduce the likelihood of image loss which may occur, when resin films (i.e., recording media) having low-temperature fixability and containing images formed thereon are stacked on one another, due to transfer of portions of images formed on the resin films to the adjacent resin films. When the styrene-alkyl(meth)acrylate copolymer is present on the surfaces of the toner particles in the above-described proportion, occurrence of migration of the specific low-molecular-weight components, which are considered to be derived from the polyester resin included in the toner particles, to the surfaces of the toner particles may be further reduced. Furthermore, irregularities are likely to be formed in the surface of an image formed on the film, which reduces the occurrence of detachment of the image.

The proportion of the styrene-alkyl(meth)acrylate copolymer in resin components deposited on the surfaces of the toner particles which is determined by XPS may be controlled by, for example, the following method. However, the method for controlling the above-described proportion is not limited thereto.

The amount of the styrene-alkyl(meth)acrylate copolymer exposed at the surfaces of the toner particles may be controlled by forming toner particles having a structure including a core (i.e., core particle) and a coating layer (i.e., shell layer) covering the core, that is, a “core-shell” structure, by a wet process. In such a case, for example, the amount of styrene-alkyl(meth)acrylate copolymer exposed can be controlled by changing the amount of styrene-alkyl(meth)acrylate copolymer particles included in the coating layer. Alternatively, styrene-alkyl(meth)acrylate copolymer particles may be added to the cores and the amount of coating layer may be changed in order to control the amount of styrene-alkyl(meth)acrylate copolymer exposed. When the toner particles include a styrene-alkyl(meth)acrylate copolymer that satisfies Relational expression (1) above, ease of controlling the proportion of the styrene-alkyl(meth)acrylate copolymer in resin components deposited on the surfaces of the toner particles to the above-described range may be increased.

The proportion of the styrene-alkyl(meth)acrylate copolymer in resin components deposited on the surfaces of the toner particles is determined by X-ray photoelectron spectroscopy (XPS) in the following manner. The C1s spectrum of the surfaces of the toner particles to be measured is subjected to waveform separation using a least square method on the basis of the C1s spectra corresponding to the styrene-alkyl(meth)acrylate copolymer, the polyester resin, and the release agent. The proportion of the styrene-alkyl(meth)acrylate copolymer is determined from the ratio of the spectrum corresponding to the styrene-alkyl(meth)acrylate copolymer obtained by the waveform separation to the C1s spectrum of the surfaces of the toner particles. The XPS measurement is conducted with “JPS-9000MX” produced by JEOL Ltd. using MgKα radiation as an X-ray source at an acceleration voltage of 10 kV and an emission current of 30 mA.

### Surface Additive

Examples of the surface additive include inorganic particles such as SiO₂ particles, TiO₂ particles, Al₂O₃ particles, CuO particles, ZnO particles, SnO₂ particles, CeO₂ particles, Fe₂O₃ particles, MgO particles, BaO particles, CaO particles, K₂O particles, Na₂O particles, ZrO₂ particles, CaO.SiO₂ particles, K₂O.TiO₂)ₙ particles, Al₂O₃.SiO₂ particles, CaCO₃ particles, MgCO₃ particles, BaSO₄ particles, and MgSO₄ particles.

The surfaces of the inorganic particles used as the surface additive may be hydrophobized. The surfaces of the inorganic particles can be hydrophobized by, for example, immersing the inorganic particles in a hydrophobizing agent. Examples of the hydrophobizing agent include, but are not particularly limited to, a silane coupling agent, silicone oil, a titanate coupling agent, and aluminium coupling agent. These hydrophobizing agents may be used alone or in combination of two or more.

In general, the amount of the hydrophobizing agent is set to, for example, 1 part by mass or more and 10 parts by mass or less relative to 100 parts by mass of the inorganic particles.

Examples of the surface additive also include resin particles (e.g., polystyrene particles, poly(methyl methacrylate) (PMMA) particles, and melamine particles) and cleaning activators (particles of a metal salt of a higher fatty acid, such as zinc stearate, and particles of a fluorine-based polymer).

The amount of the surface additive is, for example, preferably 0.01% by mass or more and 5% by mass or less and is more preferably 0.01% by mass or more and 2.0% by mass or less of the amount of the toner particles.

### Method for Producing Toner

A method for producing the toner according to the exemplary embodiment is described below.

The toner according to the exemplary embodiment is produced by, after the preparation of the toner particles, depositing a surface additive on the surfaces of the toner particles.

The toner particles may be prepared by any dry process (e.g., knead pulverization) or any wet process (e.g., aggregation coalescence, suspension polymerization, or dissolution suspension). However, a method for preparing the toner particles is not particularly limited thereto, and any suitable method known in the related art may be used.

Among these methods, aggregation coalescence may be employed in order to prepare the toner particles.

Specifically, in the case where, for example, aggregation coalescence is employed in order to prepare the toner particles, the toner particles are prepared by the following steps:

preparing a resin particle dispersion in which resin particles serving as a binder resin are dispersed (i.e., resin particle dispersion preparation step);

causing the resin particles (and, as needed, other particles) to aggregate together in the resin particle dispersion (or in the resin particle dispersion mixed with another particle dispersion as needed) in order to form aggregated particles (i.e., aggregated particle formation step);

and heating the resulting aggregated particle dispersion in which the aggregated particles are dispersed in order to cause fusion and coalescence of the aggregated particles to occur and thereby form toner particles (fusion-coalescence step).

The above-described steps are each described below in detail.

Hereinafter, a method for preparing toner particles including a colorant and a release agent is described. However, it should be noted that the colorant and the release agent are optional. It is needless to say that additives other than a colorant and a release agent may be used.

Resin Particle Dispersion Preparation Step

In addition to a resin particle dispersion in which resin particles serving as a binder resin is dispersed, for example, a colorant particle dispersion in which colorant particles are dispersed and a release-agent particle dispersion in which release-agent particles are dispersed are prepared.

The resin particle dispersion is prepared by, for example, dispersing resin particles in a dispersion medium using a surfactant.

Examples of the dispersion medium used for preparing the resin particle dispersion include aqueous media.

Examples of the aqueous media include water such as distilled water and ion-exchange water and alcohols. These aqueous media may be used alone or in combination of two or more.

Examples of the surfactant include anionic surfactants such as sulfate-based surfactants, sulfonate-based surfactants, and phosphate-based surfactants; cationic surfactants such as amine-salt-based surfactants and quaternary-ammonium-salt-based surfactants; and nonionic surfactants such as polyethylene-glycol surfactants, alkylphenol-ethylene-oxide-adduct-based surfactants, and polyhydric-alcohol-based surfactants. Among these surfactants, in particular, the anionic surfactants and the cationic surfactants may be used. The nonionic surfactants may be used in combination with the anionic surfactants and the cationic surfactants.

These surfactants may be used alone or in combination of two or more.

In the preparation of the resin particle dispersion, the resin particles can be dispersed in a dispersion medium by any suitable dispersion method commonly used in the related art in which, for example, a rotary-shearing homogenizer, a ball mill, a sand mill, or a dyno mill that includes media is used. Depending on the type of the resin particles used, the resin particles may be dispersed in the resin particle dispersion by, for example, phase-inversion emulsification.

Phase-inversion emulsification is a method in which the resin to be dispersed is dissolved in a hydrophobic organic solvent in which the resin is soluble, a base is added to the resulting organic continuous phase (i.e., O phase) to perform neutralization, subsequently an aqueous medium (i.e., W phase) is charged to convert the resin from W/O to O/W, that is, phase inversion, in order to create a discontinuous phase, and thereby the resin is dispersed in the aqueous medium in the form of particles.

The volume-average diameter of the resin particles dispersed in the resin particle dispersion is preferably, for example, 0.01 μm or more and 1 μm or less, is more preferably 0.08 μm or more and 0.8 μm or less, and is further preferably 0.1 μm or more and 0.6 μm or less.

The volume-average diameter of the resin particles is determined in the following manner. The particle diameter distribution of the resin particles is obtained using a laser-diffraction-type particle-size-distribution measurement apparatus (e.g., “LA-700” produced by HORIBA, Ltd.). The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v. The volume-average diameters of particles included in the other dispersions are also determined in the above-described manner.

The content of the resin particles included in the resin particle dispersion is preferably, for example, 5% by mass or more and 50% by mass or less and is more preferably 10% by mass or more and 40% by mass or less.

The colorant particle dispersion, the release-agent particle dispersion, and the like are also prepared as in the preparation of the resin particle dispersion. In other words, the above-described specifications for the volume-average diameter of the particles included in the resin particle dispersion, the dispersion medium of the resin particle dispersion, the dispersion method used for preparing the resin particle dispersion, and the content of the particles in the resin particle dispersion can also be applied to colorant particles dispersed in the colorant particle dispersion and release-agent particles dispersed in the release-agent particle dispersion.

Aggregated Particle Formation Step

The resin particle dispersion is mixed with the colorant particle dispersion and the release-agent particle dispersion.

In the resulting mixed dispersion, heteroaggregation of the resin particles with the colorant particles and the release-agent particles is performed in order to form aggregated particles including the resin particles, the colorant particles, and the release-agent particles, the aggregated particles having a diameter close to that of the desired toner particles.

Specifically, for example, a flocculant is added to the mixed dispersion, and the pH of the mixed dispersion is controlled to be acidic (e.g., pH of 2 or more and 5 or less). A dispersion stabilizer may be added to the mixed dispersion as needed. Subsequently, the mixed dispersion is heated to the glass transition temperature of the resin particles (specifically, e.g., [glass transition temperature of the resin particles−30° C.] or more and [the glass transition temperature−10° C.] or less), and thereby the particles dispersed in the mixed dispersion are caused to aggregate together to form aggregated particles.

In the aggregated particle formation step, alternatively, for example, the above-described flocculant may be added to the mixed dispersion at room temperature (e.g., 25° C.) while the mixed dispersion is stirred using a rotary-shearing homogenizer. Then, the pH of the mixed dispersion is controlled to be acidic (e.g., pH of 2 or more and 5 or less), and a dispersion stabilizer may be added to the mixed dispersion as needed. Subsequently, the mixed dispersion is heated in the above-described manner.

Examples of the flocculant include surfactants, inorganic metal salts, and divalent or higher polyvalent metal complexes that have a polarity opposite to that of the surfactant that is added to the mixed dispersion as a dispersant. In particular, using a metal complex as a flocculant reduces the amount of surfactant used and, as a result, charging characteristics may be enhanced.

An additive capable of forming a complex or a bond similar to a complex with the metal ions contained in the flocculant such as a chelating agent may optionally be used.

Examples of the inorganic metal salts include metal salts such as calcium chloride, calcium nitrate, barium chloride, magnesium chloride, zinc chloride, aluminium chloride, and aluminium sulfate; and inorganic metal salt polymers such as polyaluminium chloride, polyaluminium hydroxide, and calcium polysulfide.

The chelating agent may be a water-soluble chelating agent. Examples of such a chelating agent include oxycarboxylic acids such as tartaric acid, citric acid, and gluconic acid, imino diacid (IDA), nitrilotriacetic acid (NTA), and ethylenediaminetetraacetic acid (EDTA).

The amount of the chelating agent used is preferably 0.01 parts by mass or more and 5.0 parts by mass or less and is more preferably 0.1 parts by mass or more and less than 3.0 parts by mass relative to 100 parts by mass of the resin particles.

Fusion-Coalescence Step

The aggregated particle dispersion in which the aggregated particles are dispersed is heated to, for example, the glass transition temperature of the resin particles or more (e.g., temperature higher than the glass transition temperature of the resin particles by 10 to 30° C.) in order to perform fusion and coalescence of the aggregated particles. Thus, toner particles are prepared.

The toner particles are prepared through the above-described steps.

It is also possible to prepare the toner particles by, after preparing the aggregated particle dispersion in which the aggregated particles are dispersed, further mixing the aggregated particle dispersion with a resin particle dispersion in which resin particles are dispersed and subsequently performing aggregation such that the resin particles are deposited on the surfaces of the aggregated particles in order to form second aggregated particles; and by heating the resulting second-aggregated particle dispersion in which the second aggregated particles are dispersed and thereby causing fusion and coalescence of the second aggregated particles to occur in order to form toner particles having a core-shell structure.

After the completion of the fusion-coalescence step, the toner particles formed in the solution are subjected to any suitable cleaning step, solid-liquid separation step, and drying step that are known in the related art in order to obtain dried toner particles.

In the cleaning step, the toner particles may be subjected to displacement washing using ion-exchange water to a sufficient degree from the viewpoint of electrification characteristics. Examples of a solid-liquid separation method employed in the solid-liquid separation step include, but are not limited to, suction filtration and pressure filtration from the viewpoint of productivity. Examples of a drying method employed in the drying step include, but are not particularly limited to, freeze-drying, flash-jet drying, fluidized drying, and vibrating fluidized drying from the viewpoint of productivity.

The toner according to the exemplary embodiment is produced by, for example, adding a surface additive to the dried toner particles and mixing the resulting toner particles using a V-blender, a Henschel mixer, a Lodige mixer, or the like. Optionally, coarse toner particles may be removed using a vibrating screen classifier, a wind screen classifier, or the like.

### Electrostatic-Image Developer

The electrostatic-image developer according to an exemplary embodiment includes at least the toner according to the above-described exemplary embodiment.

The electrostatic-image developer according to the exemplary embodiment may be a monocomponent developer including only the above-described toner or may be a two-component developer that is a mixture of the above-described toner and a carrier.

The type of the carrier is not particularly limited, and any suitable carrier known in the related art may be used. Examples of the carrier include a coated carrier prepared by coating the surfaces of cores including magnetic powder particles with a coat resin; a magnetic-powder-dispersed carrier prepared by dispersing and mixing magnetic powder particles in a matrix resin; and a resin-impregnated carrier prepared by impregnating a porous magnetic powder with a resin.

The magnetic-powder-dispersed carrier and the resin-impregnated carrier may also be prepared by coating particles constituting the carrier, that is, core particles, with a coat resin.

Examples of the magnetic powder include powders of magnetic metals such as iron, nickel, and cobalt; and powders of magnetic oxides such as ferrite and magnetite.

Examples of the coat resin and the matrix resin include polyethylene, polypropylene, polystyrene, poly(vinyl acetate), poly(vinyl alcohol), poly(vinyl butyral), poly(vinyl chloride), poly(vinyl ether), poly(vinyl ketone), a vinyl chloride-vinyl acetate copolymer, a styrene-acrylic acid copolymer, a straight silicone resin including an organosiloxane bond and the modified products thereof, a fluorine resin, polyester, polycarbonate, a phenolic resin, and an epoxy resin.

The coat resin and the matrix resin may optionally include additives such as conductive particles.

Examples of the conductive particles include particles of metals such as gold, silver, and copper; and particles of carbon black, titanium oxide, zinc oxide, tin oxide, barium sulfate, aluminium borate, and potassium titanate.

The surfaces of the cores can be coated with a coat resin by, for example, using a coating-layer forming solution prepared by dissolving the coat resin and, as needed, various types of additives in a suitable solvent. The type of the solvent is not particularly limited and may be selected with consideration of the coat resin used, ease of applying the coating-layer forming solution, and the like.

Specific examples of a method for coating the surfaces of the cores with the coat resin include an immersion method in which the cores are immersed in the coating-layer forming solution; a spray method in which the coating-layer forming solution is sprayed onto the surfaces of the cores; a fluidized-bed method in which the coating-layer forming solution is sprayed onto the surfaces of the cores while the cores are floated using flowing air; and a kneader-coater method in which the cores of the carrier are mixed with the coating-layer forming solution in a kneader coater and subsequently the solvent is removed.

The mixing ratio (i.e., mass ratio) of the toner to the carrier in the two-component developer is preferably toner:carrier=1:100 to 30:100 and is more preferably 3:100 to 20:100.

### Image Forming Apparatus and Image Forming Method

The image forming apparatus and the image forming method according to an exemplary embodiment are described below.

The image forming apparatus according to the exemplary embodiment includes an image carrier; a charging unit that charges the surface of the image carrier; an electrostatic-image forming unit that forms an electrostatic image on the surface of the image carrier charged; a developing unit that includes an electrostatic-image developer and develops the electrostatic image formed on the surface of the image carrier using the electrostatic-image developer to form a toner image; a transfer unit that transfers the toner image formed on the surface of the image carrier onto the surface of a recording medium; and a fixing unit that fixes the toner image onto the surface of the recording medium. The electrostatic-image developer according to the above-described exemplary embodiment is used as an electrostatic-image developer.

The image forming apparatus according to the exemplary embodiment employs an image forming method (image forming method according to the exemplary embodiment) including charging the surface of the image carrier; forming an electrostatic image on the surface of the charged image carrier; developing the electrostatic image formed on the surface of the image carrier using the electrostatic-image developer according to the above-described exemplary embodiment to form a toner image; transferring the toner image formed on the surface of the image carrier onto the surface of a recording medium; and fixing the toner image onto the surface of the recording medium.

The image forming apparatus according to the exemplary embodiment may be any image forming apparatus known in the related art, such as a direct-transfer-type image forming apparatus in which a toner image formed on the surface of the image carrier is directly transferred to a recording medium; an intermediate-transfer-type image forming apparatus in which a toner image formed on the surface of the image carrier is transferred onto the surface of the intermediate transfer body in the first transfer step and the toner image transferred on the surface of the intermediate transfer body is again transferred onto the surface of a recording medium in the second transfer step; an image forming apparatus including a cleaning unit that cleans the surface of the image carrier subsequent to transfer of the toner image before the image carrier is again charged; and an image forming apparatus including a static-eliminating unit that eliminates static by irradiating, after the toner image has been transferred, the surface of the image carrier to be again charged with static-eliminating light.

The intermediate-transfer-type image forming apparatus may include a transfer unit constituted by, for example, an intermediate transfer body to which a toner image is transferred, a first transfer subunit that transfers a toner image formed on the surface of the image carrier onto the surface of the intermediate transfer body in the first transfer step, and a second transfer subunit that transfers the toner image transferred on the surface of the intermediate transfer body onto the surface of a recording medium in the second transfer step.

In the image forming apparatus according to the exemplary embodiment, for example, a portion including the developing unit may have a cartridge structure (i.e., process cartridge) detachably attached to the image forming apparatus. An example of the process cartridge is a process cartridge including a developing unit including the electrostatic-image developer according to the above-described exemplary embodiment.

An example of the image forming apparatus according to the exemplary embodiment is described below, but the image forming apparatus is not limited thereto. Only components shown in drawings are described; others are omitted.

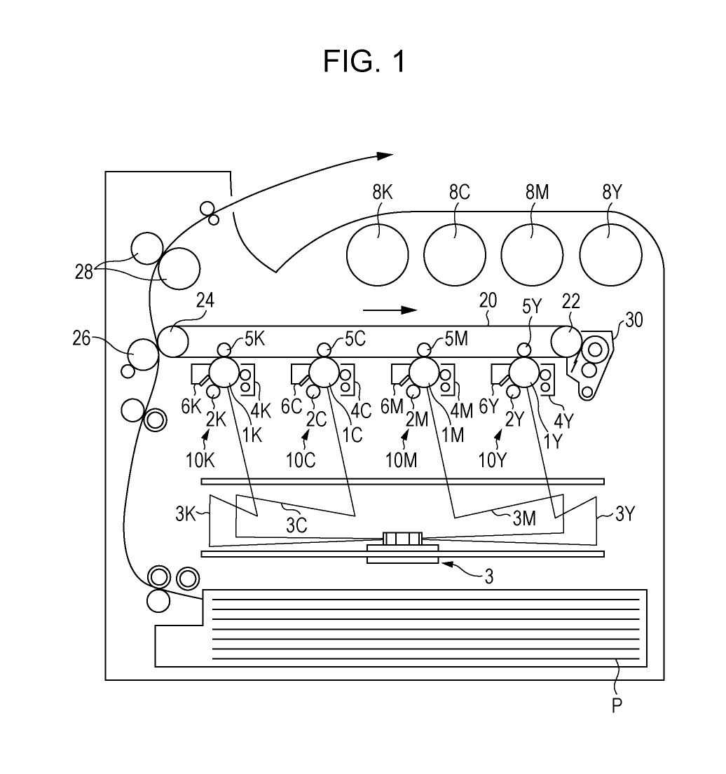

FIG. 1 schematically illustrates the image forming apparatus according to the exemplary embodiment.

The image forming apparatus illustrated in FIG. 1 includes first to fourth electrophotographic image forming units 10Y, 10M, 10C, and 10K that form yellow (Y), magenta (M), cyan (C), and black (K) images, respectively, on the basis of color separation image data. The image forming units (hereafter, referred to simply as “units”) 10Y, 10M, 10C, and 10K are horizontally arranged in parallel at a predetermined distance from one another. The units 10Y, 10M, 10C, and 10K may be process cartridges detachably attached to the image forming apparatus.

An intermediate transfer belt 20 serving as an intermediate transfer body runs above and through the units 10Y, 10M, 10C, and 10K in FIG. 1. The intermediate transfer belt 20 is wound around a drive roller 22 and a support roller 24, which are spaced apart from each other and brought into contact with the inner surface of the intermediate transfer belt 20. The intermediate transfer belt 20 runs clockwise in FIG. 1, i.e., in the direction from the first unit 10Y to the fourth unit 10K. Using a spring or the like (not shown), a force is applied to the support roller 24 in a direction away from the drive roller 22, thereby applying tension to the intermediate transfer belt 20 wound around the drive roller 22 and the support roller 24. An intermediate transfer body-cleaning device 30 is disposed so as to come into contact with the image-carrier-side surface of the intermediate transfer belt 20 and to face the drive roller 22.

Developing devices (i.e., developing units) 4Y, 4M, 4C, and 4K of units 10Y, 10M, 10C, and 10K are supplied with yellow, magenta, cyan, and black toners stored in toner cartridges 8Y, 8M, 8C, and 8K, respectively.

Since the first to fourth units 10Y, 10M, 10C, and 10K have the same structure, the following description is made with reference to, as a representative, the first unit 10Y that forms an yellow image and is located upstream in a direction in which the intermediate transfer belt runs. Same members are labeled with the same reference numeral as the reference numeral of the first unit 10Y except that magenta (M), cyan (C), or black (K) is used instead of yellow (Y) and the description of the second to fourth units 10M, 10C, and 10K are omitted.

The first unit 10Y includes a photosensitive member 1Y serving as an image carrier. The following components are disposed around the photosensitive member 1Y sequentially in the counterclockwise direction: a charging roller (example of the charging unit) 2Y that charges the surface of the photosensitive member 1Y at a predetermined potential; an exposure device (example of the electrostatic-image forming unit) 3 that forms an electrostatic image by irradiating the charged surface of the photosensitive member 1Y with a laser beam 3Y based on a color separated image signal; a developing device (example of the developing unit) 4Y that develops the electrostatic image by supplying a charged toner to the electrostatic image; a first transfer roller (example of the first transfer subunit) 5Y that transfers the developed toner image to the intermediate transfer belt 20; and a photosensitive-member cleaning device (example of the cleaning unit) 6Y that removes a toner remaining on the surface of the photosensitive member 1Y after the first transfer.

The first transfer roller 5Y is disposed so as to be in contact with the inner surface of the intermediate transfer belt 20 and to face the photosensitive member 1Y. The first transfer rollers 5Y, 5M, 5C, and 5K are each connected to a bias power supply (not shown) that applies a first transfer bias to the first transfer rollers. Each bias power supply varies the transfer bias applied to the corresponding first transfer roller on the basis of the control by a controller (not shown).

The action of forming a yellow image in the first unit 10Y is described below.

Before the action starts, the surface of the photosensitive member 1Y is charged at a potential of −600 to −800 V by the charging roller 2Y.

The photosensitive member 1Y is formed by stacking a photosensitive layer on a conductive substrate (e.g., volume resistivity at 20° C.: 1×10⁻⁶ Ωcm or less). The photosensitive layer is normally of high resistance (comparable with the resistance of ordinary resins), but, upon being irradiated with the laser beam 3Y, the specific resistance of the portion irradiated with the laser beam varies. Thus, the exposure device 3 irradiates the surface of the charged photosensitive member 1Y with the laser beam 3Y on the basis of the image data of the yellow image sent from the controller (not shown). The photosensitive layer on the surface of the photosensitive member 1Y is irradiated with the laser beam 3Y, and thereby an electrostatic image of yellow image pattern is formed on the surface of the photosensitive member 1Y.

The term “electrostatic image” used herein refers to an image formed on the surface of the photosensitive member 1Y by charging, the image being a “negative latent image” formed by irradiating a portion of the photosensitive layer with the laser beam 3Y to reduce the specific resistance of the irradiated portion such that the charges on the irradiated surface of the photosensitive member 1Y discharge while the charges on the portion that is not irradiated with the laser beam 3Y remain.

The electrostatic image, which is formed on the photosensitive member 1Y as described above, is sent to the predetermined developing position by the rotating photosensitive member 1Y. The electrostatic image on the photosensitive member 1Y is visualized (i.e., developed) in the form of a toner image by the developing device 4Y at the developing position.

The developing device 4Y includes an electrostatic-image developer including a yellow toner and a carrier. The yellow toner is stirred in the developing device 4Y to be charged by friction and supported on a developer roller (example of the developer support), carrying an electric charge of the same polarity (i.e., negative) as the electric charge generated on the photosensitive member 1Y. The yellow toner is electrostatically adhered to the eliminated latent image portion on the surface of the photosensitive member 1Y as the surface of the photosensitive member 1Y passes through the developing device 4Y. Thus, the latent image is developed using the yellow toner. The photosensitive member 1Y on which the yellow toner image is formed keeps rotating at the predetermined rate, thereby transporting the toner image developed on the photosensitive member 1Y to the predetermined first transfer position.

Upon the yellow toner image on the photosensitive member 1Y reaching the first transfer position, first transfer bias is applied to the first transfer roller 5Y so as to generate an electrostatic force on the toner image in the direction from the photosensitive member 1Y toward the first transfer roller 5Y. Thus, the toner image on the photosensitive member 1Y is transferred to the intermediate transfer belt 20. The transfer bias applied has the opposite polarity (+) to that of the toner (−) and controlled to be, for example, in the first unit 10Y, +10 μA by a controller (not shown).

The toner remaining on the photosensitive member 1Y is removed by the photosensitive-member cleaning device 6Y and then collected.

The first transfer biases applied to first transfer rollers 5M, 5C, and 5K of the second, third, and fourth units 10M, 10C, and 10K are each controlled in accordance with the first unit 10Y.

Thus, the intermediate transfer belt 20, on which the yellow toner image is transferred in the first unit 10Y, is successively transported through the second to fourth units 10M, 10C, and 10K while toner images of the respective colors are stacked on top of another.

The resulting intermediate transfer belt 20 on which toner images of four colors are multiple-transferred in the first to fourth units is then transported to a second transfer section including a support roller 24 being in contact with the inner surface of the intermediate transfer belt 20 and a second transfer roller (example of the second transfer subunit) 26 disposed on the image-carrier-side of the intermediate transfer belt 20. A recording paper (example of the recording medium) P is fed by a feed mechanism into a narrow space between the second transfer roller 26 and the intermediate transfer belt 20 that are brought into contact with each other at the predetermined timing. The second transfer bias is then applied to the support roller 24. The transfer bias applied here has the same polarity (−) as that of the toner (−) and generates an electrostatic force on the toner image in the direction from the intermediate transfer belt 20 toward the recording paper P. Thus, the toner image on the intermediate transfer belt 20 is transferred to the recording paper P. The intensity of the second transfer bias applied is determined on the basis of the resistance of the second transfer section which is detected by a resistance detector (not shown) that detects the resistance of the second transfer section and controlled by changing voltage.

Subsequently, the recording paper P is transported into a nip part of the fixing device (example of the fixing unit) 28 at which a pair of fixing rolls are brought into contact with each other. The toner image is fixed to the recording paper P to form a fixed image.

Examples of the recording paper P to which a toner image is transferred include films such as OHP films and paper such as plain paper used in electrophotographic copiers, printers, and the like.

In the case where the recording paper P is paper, the surface of the recording paper P may also be smooth in order to enhance the smoothness of the surface of the fixed image. Examples of such a recording paper include coated paper produced by coating the surface of plain paper with resin or the like and art paper for printing.

The recording paper P, to which the color image has been fixed, is transported toward an exit portion. Thus, the series of the steps for forming a color image are terminated.

### Process Cartridge and Toner Cartridge

The process cartridge according to an exemplary embodiment is described below.

The process cartridge according to the exemplary embodiment includes a developing unit that includes the electrostatic-image developer according to the above-described exemplary embodiment and develops an electrostatic image formed on the surface of an image carrier using the electrostatic-image developer to form a toner image. The process cartridge according to the exemplary embodiment is detachably attachable to an image forming apparatus.

The structure of the process cartridge according to the exemplary embodiment is not limited to the above-described one. The process cartridge according to the exemplary embodiment may further include, in addition to the developing unit, at least one unit selected from an image carrier, a charging unit, an electrostatic-image forming unit, a transfer unit, and the like as needed.

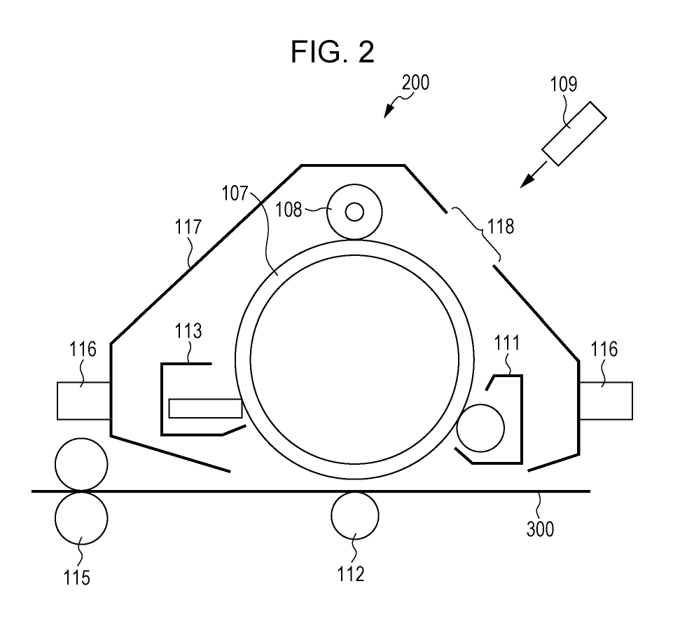

An example of the process cartridge according to the exemplary embodiment is described below, but the process cartridge is not limited thereto. Only components illustrated in FIG. 2 are described; others are omitted.

FIG. 2 schematically illustrates the process cartridge according to the exemplary embodiment.

A process cartridge 200 illustrated in FIG. 2 includes, for example, a photosensitive member 107 (example of the image carrier), a charging roller 108 (example of the charging unit) disposed on the periphery of the photosensitive member 107, a developing device 111 (example of the developing unit), and a photosensitive-member-cleaning device 113 (example of the cleaning unit), which are combined into one unit using a housing 117 to form a cartridge. The housing 117 has an aperture 118 for exposure. A mounting rail 116 is disposed on the housing 117.

In FIG. 2, Reference numeral 109 denotes an exposure device (example of the electrostatic-image forming unit), Reference numeral 112 denotes a transfer device (example of the transfer unit), Reference numeral 115 denotes a fixing device (example of the fixing unit), and the Reference numeral 300 denotes recording paper (example of the recording medium).

The toner cartridge according to an exemplary embodiment is described below.

The toner cartridge according to the exemplary embodiment includes the toner according to the above-described exemplary embodiment and is detachably attachable to an image forming apparatus. The toner cartridge includes a toner that is to be supplied to a developing unit disposed inside an image forming apparatus.

### EXAMPLES

The above-described exemplary embodiments are described specifically with reference to Examples and Comparative Examples below, but the above-described exemplary embodiments are not limited thereto. In Examples and Comparative Examples, all “part” and “%” are by mass unless otherwise specified.

### Preparation of Amorphous Polyester Resin Particle Dispersion

Bisphenol A-ethylene oxide 2-mol adduct: 20 mol %

Bisphenol A-propylene oxide 2-mol adduct: 30 mol %

Terephthalic acid: 30 mol %

Dodecenyl succinic anhydride: 10 mol %

Trimellitic anhydride: 10 mol %

The above monomer components were charged into a reactor equipped with a stirrer, a thermometer, a condenser, and a nitrogen-gas introduction tube. After the reactor was purged with dry nitrogen gas, dibutyltin oxide was added to the reactor as a catalyst such that the amount of the dibutyltin oxide was 1.0% of the total amount of the above monomer components. The resulting mixture was stirred under a nitrogen gas stream at about 190° C. for 6 hours to cause a reaction. Subsequently, the temperature was increased to about 240° C. and the reaction was continued for about 6 hours under stirring. Then, the pressure inside the reactor was reduced to 10.0 mmHg, and the reaction was further continued for about 0.5 hours under a reduced pressure while the mixture was stirred. Thus, a yellow transparent amorphous polyester resin A was prepared. The amorphous polyester resin A had a glass transition temperature of 57° C.

A dispersion of the amorphous polyester resin A was formed using a disperser prepared by adapting a “CAVITRON CD1010” (produced by Eurotec, Ltd.) for high-temperature, high-pressure use. Specifically, the composition ratio of ion-exchange water to the polyester resin A was set to 80:20, the pH of the dispersion was set to 8.5 using ammonia, and CAVITRON was operated under the following conditions: rotation speed of rotor: 60Hz; pressure: 5 kg/cm²; and heating temperature of heat exchanger: 140° C. Thus, an amorphous polyester resin particle dispersion A (solid content: 20%) was prepared.

Preparation of Amorphous Polyester Resin Particle Dispersion B

Bisphenol A-ethylene oxide 2-mol adduct: 10 mol %

Bisphenol A-propylene oxide 2-mol adduct: 40 mol %

Terephthalic acid: 40 mol %

Dodecenyl succinic anhydride: 5 mol %

Trimellitic anhydride: 5 mol %

The above monomer components were charged into a reactor equipped with a stirrer, a thermometer, a condenser, and a nitrogen-gas introduction tube. After the reactor was purged with dry nitrogen gas, dibutyltin oxide was added to the reactor as a catalyst such that the amount of the dibutyltin oxide was 1.0% of the total amount of the above monomer components. The resulting mixture was stirred under a nitrogen gas stream at about 190° C. for 6 hours to cause a reaction. Subsequently, the temperature was increased to about 240° C. and the reaction was continued for about 6 hours under stirring. Then, the pressure inside the reactor was reduced to 10.0 mmHg, and the reaction was further continued for about 0.5 hours under a reduced pressure while the mixture was stirred. Thus, a yellow transparent amorphous polyester resin B was prepared. The amorphous polyester resin B had a glass transition temperature of 55° C.

An amorphous polyester resin particle dispersion B (solid content: 20%) was prepared as in the preparation of the amorphous polyester resin particle dispersion A.

### Preparation of Amorphous Polyester Resin Particle Dispersion C

Bisphenol A-ethylene oxide 2-mol adduct: 20 mol %

Bisphenol A-propylene oxide 2-mol adduct: 30 mol %

Terephthalic acid: 20 mol %

Dodecenyl succinic anhydride: 15 mol %

Trimellitic anhydride: 15 mol %

The above monomer components were charged into a reactor equipped with a stirrer, a thermometer, a condenser, and a nitrogen-gas introduction tube. After the reactor was purged with dry nitrogen gas, dibutyltin oxide was added to the reactor as a catalyst such that the amount of the dibutyltin oxide was 1.0% of the total amount of the above monomer components. The resulting mixture was stirred under a nitrogen gas stream at about 190° C. for 6 hours to cause a reaction. Subsequently, the temperature was increased to about 240° C. and the reaction was continued for about 6 hours under stirring. Then, the pressure inside the reactor was reduced to 10.0 mmHg, and the reaction was further continued for about 0.5 hours under a reduced pressure while the mixture was stirred. Thus, a yellow transparent amorphous polyester resin C was prepared. The amorphous polyester resin C had a glass transition temperature of 58° C.

An amorphous polyester resin particle dispersion C (solid content: 20%) was prepared as in the preparation of the amorphous polyester resin particle dispersion A.

### Preparation of Amorphous Polyester Resin Particle Dispersion D

Bisphenol A-ethylene oxide 2-mol adduct: 20 mol %

Bisphenol A-propylene oxide 2-mol adduct: 30 mol %

Terephthalic acid: 30 mol %

Dodecenyl succinic anhydride: 10 mol %

Trimellitic anhydride: 10 mol %

The above monomer components were charged into a reactor equipped with a stirrer, a thermometer, a condenser, and a nitrogen-gas introduction tube. After the reactor was purged with dry nitrogen gas, dibutyltin oxide was added to the reactor as a catalyst such that the amount of the dibutyltin oxide was 1.0% of the total amount of the above monomer components. The resulting mixture was stirred under a nitrogen gas stream at about 190° C. for 5 hours to cause a reaction. Subsequently, the temperature was increased to about 220° C. and the reaction was continued for about 5 hours under stirring. Then, the pressure inside the reactor was reduced to 10.0 mmHg, and the reaction was further continued for about 0.5 hours under a reduced pressure while the mixture was stirred. Thus, a yellow transparent amorphous polyester resin D was prepared. The amorphous polyester resin D had a glass transition temperature of 57° C.

An amorphous polyester resin particle dispersion D (solid content: 20%) was prepared as in the preparation of the amorphous polyester resin particle dispersion A.

### Preparation of Amorphous Polyester Resin Particle Dispersion E

Bisphenol A-ethylene oxide 2-mol adduct: 20 mol %

Bisphenol A-propylene oxide 2-mol adduct: 30 mol %

Terephthalic acid: 30 mol %

Dodecenyl succinic anhydride: 10 mol %

Trimellitic anhydride: 10 mol %

The above monomer components were charged into a reactor equipped with a stirrer, a thermometer, a condenser, and a nitrogen-gas introduction tube. After the reactor was purged with dry nitrogen gas, dibutyltin oxide was added to the reactor as a catalyst such that the amount of the dibutyltin oxide was 1.0% of the total amount of the above monomer components. The resulting mixture was stirred under a nitrogen gas stream at about 190° C. for 5 hours to cause a reaction. Subsequently, the temperature was increased to about 210° C. and the reaction was continued for about 4 hours under stirring. Then, the pressure inside the reactor was reduced to 10.0 mmHg, and the reaction was further continued for about 0.5 hours under a reduced pressure while the mixture was stirred. Thus, a yellow transparent amorphous polyester resin E was prepared. The amorphous polyester resin E had a glass transition temperature of 57° C.

An amorphous polyester resin particle dispersion E (solid content: 20%) was prepared as in the preparation of the amorphous polyester resin particle dispersion A.

### Preparation of Crystalline Polyester Resin Dispersion A

Sebacic acid: 50 mol %

1,6-Hexanediol: 50 mol %

The above monomer components were mixed with dibutyltin oxide in a flask such that the amount of dibutyltin oxide was 0.3% of the total amount of the monomer components. The resulting mixture was heated to 240° C. under a reduced-pressure atmosphere, and a dehydration condensation reaction was performed for 6 hours to prepare a crystalline polyester resin A.

Subsequently, 300 parts of the crystalline polyester resin A, 160 parts of methyl ethyl ketone (solvent), and 100 parts of isopropyl alcohol (solvent) were charged into a 3-L jacket-type reaction vessel (“BJ-30N” produced by TOKYO RIKAKIKAI CO, LTD) equipped with a condenser, a thermometer, a water dropper, and an anchor stirring shaft. These components were mixed under stirring at 100 rpm while the temperature was maintained to be 70° C. in a water-circulation-type thermostat in order to dissolve the resin (Solution Preparation Step).

Subsequently, the number of rotation of the stirrer was set to 150 rpm, and the temperature of the water-circulation-type thermostat was set to 66° C. To the solution of the crystalline polyester resin A, 17 parts of a 10%-ammonia water (reagent) was added over 10 minutes, and subsequently 900 parts of ion-exchange water kept at 66° C. was added dropwise to the resulting solution at a rate of 7 part/min in order to perform phase inversion. Thus, an emulsion was prepared.

Immediately after preparation of the emulsion, 800 parts of the emulsion and 700 parts of ion-exchange water were charged into a 2-L eggplant flask, and the flask was fixed to an evaporator (produced by TOKYO RIKAKIKAI CO, LTD) equipped with a vacuum control unit with a trap ball interposed between the flask and the evaporator. The mixture was heated in a hot-water bath kept at 60° C. while the eggplant flask was rotated, and the pressure inside the flask was reduced to 7 kPa while taking care to prevent bumping. Thus, the solvents were removed. When the amount of the solvents collected reached 1,100 parts, the pressure inside the eggplant flask was increased to the normal pressure, and the eggplant flask was water-cooled to prepare a dispersion. The solid-content concentration in the dispersion was controlled to be 20% by adding ion-exchange water to the dispersion. Thus, a crystalline polyester resin dispersion A was prepared.

### Preparation of Crystalline Polyester Resin Dispersion B

1,14-Tetradecanedicarboxylic acid: 50 mol %

1,14-Tetradecanediol: 50 mol %

The above monomer components were mixed with dibutyltin oxide in a flask such that the amount of dibutyltin oxide was 0.3% of the total amount of the monomer components. The resulting mixture was heated to 240° C. under a reduced-pressure atmosphere, and a dehydration condensation reaction was performed for 6 hours to prepare a crystalline polyester resin B.

A crystalline polyester resin dispersion B was prepared as in the preparation of the crystalline polyester resin dispersion A. The solid-content concentration in the dispersion was also controlled to be 20%.

### Preparation of Styrene-Alkyl(Meth)Acrylate Copolymer Particle Dispersion A

Styrene (produced by Wako Pure Chemical Industries, Ltd.): 453 parts

n-Butyl acrylate (produced by Wako Pure Chemical Industries, Ltd.): 102 parts

1,10-Decanediol diacrylate (produced by Shin Nakamura Chemical Co., Ltd.): 2 parts

Dodecanethiol (produced by Wako Pure Chemical Industries, Ltd.): 4 parts

The above components were mixed together and dissolved in a flask. A solution prepared by dissolving 4.5 parts of an anionic surfactant “Dowfax” (produced by Dow Chemical Company) in 1,050 parts of ion-exchange water was added to the flask, and emulsification was performed in the flask. While the contents of the flask were slowly stirred for 10 minutes, 50 parts of ion-exchange water in which 5 parts of ammonium persulfate was dissolved was further added to the flask. After the flask was purged with nitrogen, the solution contained in the flask was heated to 65° C. in an oil bath while being stirred, and emulsion polymerization was continued for 5 hours. Thus, a styrene-alkyl(meth)acrylate copolymer particle dispersion A which had a solid content of 34% was prepared.

The styrene-alkyl(meth)acrylate copolymer A had a glass transition temperature of 57° C. and a weight-average molecular weight Mw of 56,000.

### Preparation of Styrene-Alkyl(Meth)Acrylate Copolymer Particle Dispersion B

Styrene (produced by Wako Pure Chemical Industries, Ltd.): 460 parts

n-Butyl acrylate (produced by Wako Pure Chemical Industries, Ltd.): 95 parts

1,10-Decanediol diacrylate (produced by Shin Nakamura Chemical Co., Ltd.): 2 parts

Dodecanethiol (produced by Wako Pure Chemical Industries, Ltd.): 4 parts

A styrene-alkyl(meth)acrylate copolymer particle dispersion B which had a solid content of 34% was prepared as in the preparation of the styrene-alkyl(meth)acrylate copolymer particle dispersion A, except that the above components were used instead.

The styrene-alkyl(meth)acrylate copolymer B had a glass transition temperature of 59.5° C. and a weight-average molecular weight Mw of 56,000.

### Preparation of Styrene-Alkyl(Meth)Acrylate Copolymer Particle Dispersion C

Styrene (produced by Wako Pure Chemical Industries, Ltd.): 420 parts

n-Butyl acrylate (produced by Wako Pure Chemical Industries, Ltd.): 135 parts

1,10-Decanediol diacrylate (produced by Shin Nakamura Chemical Co., Ltd.): 2 parts

Dodecanethiol (produced by Wako Pure Chemical Industries, Ltd.): 4 parts

A styrene-alkyl(meth)acrylate copolymer particle dispersion C which had a solid content of 34% was prepared as in the preparation of the styrene-alkyl(meth)acrylate copolymer particle dispersion A, except that the above components were used instead.

The styrene-alkyl(meth)acrylate copolymer C had a glass transition temperature of 45° C. and a weight-average molecular weight Mw of 56,000.

### Preparation of Styrene-Alkyl(Meth)Acrylate Copolymer Particle Dispersion D

Styrene (produced by Wako Pure Chemical Industries, Ltd.): 464 parts

n-Butyl acrylate (produced by Wako Pure Chemical Industries, Ltd.): 91 parts

1,10-Decanediol diacrylate (produced by Shin Nakamura Chemical Co., Ltd.): 2 parts

Dodecanethiol (produced by Wako Pure Chemical Industries, Ltd.): 4 parts

A styrene-alkyl(meth)acrylate copolymer particle dispersion D which had a solid content of 34% was prepared as in the preparation of the styrene-alkyl(meth)acrylate copolymer particle dispersion A, except that the above components were used instead.

The styrene-alkyl(meth)acrylate copolymer D had a glass transition temperature of 61° C. and a weight-average molecular weight Mw of 56,000.

### Preparation of Styrene-Alkyl(Meth)Acrylate Copolymer Particle Dispersion E

Styrene (produced by Wako Pure Chemical Industries, Ltd.): 417 parts

n-Butyl acrylate (produced by Wako Pure Chemical Industries, Ltd.): 138 parts

1,10-Decanediol diacrylate (produced by Shin Nakamura Chemical Co., Ltd.): 2 parts

Dodecanethiol (produced by Wako Pure Chemical Industries, Ltd.): 4 parts

A styrene-alkyl(meth)acrylate copolymer particle dispersion E which had a solid content of 34% was prepared as in the preparation of the styrene-alkyl(meth)acrylate copolymer particle dispersion A, except that the above components were used instead.

The styrene-alkyl(meth)acrylate copolymer E had a glass transition temperature of 44° C. and a weight-average molecular weight Mw of 56,000.

### Preparation of Styrene-Alkyl(Meth)Acrylate Copolymer Particle Dispersion F

Styrene (produced by Wako Pure Chemical Industries, Ltd.): 448 parts

n-Butyl acrylate (produced by Wako Pure Chemical Industries, Ltd.): 107 parts

1,10-Decanediol diacrylate (produced by Shin Nakamura Chemical Co., Ltd.): 6 parts

Dodecanethiol (produced by Wako Pure Chemical Industries, Ltd.): 2 parts

A styrene-alkyl(meth)acrylate copolymer particle dispersion F which had a solid content of 34% was prepared as in the preparation of the styrene-alkyl(meth)acrylate copolymer particle dispersion A, except that the above components were used instead.

The styrene-alkyl(meth)acrylate copolymer F had a glass transition temperature of 57° C. and a weight-average molecular weight Mw of 65,000.

### Preparation of Styrene-Alkyl(Meth)Acrylate Copolymer Particle Dispersion G

Styrene (produced by Wako Pure Chemical Industries, Ltd.): 459 parts

n-Butyl acrylate (produced by Wako Pure Chemical Industries, Ltd.): 96 parts

1,10-Decanediol diacrylate (produced by Shin Nakamura Chemical Co., Ltd.): 1 part

Dodecanethiol (produced by Wako Pure Chemical Industries, Ltd.): 6 parts

A styrene-alkyl(meth)acrylate copolymer particle dispersion G which had a solid content of 34% was prepared as in the preparation of the styrene-alkyl(meth)acrylate copolymer particle dispersion A, except that the above components were used instead.

The styrene-alkyl(meth)acrylate copolymer G had a glass transition temperature of 57° C. and a weight-average molecular weight Mw of 40,000.

### Preparation of Styrene-Alkyl(Meth)Acrylate Copolymer Particle Dispersion H

Styrene (produced by Wako Pure Chemical Industries, Ltd.): 416 parts

Ethyl acrylate (produced by Wako Pure Chemical Industries, Ltd.): 139 parts

1,10-Decanediol diacrylate (produced by Shin Nakamura Chemical Co., Ltd.): 1 part

Dodecanethiol (produced by Wako Pure Chemical Industries, Ltd.): 6 parts

A styrene-alkyl(meth)acrylate copolymer particle dispersion H which had a solid content of 34% was prepared as in the preparation of the styrene-alkyl(meth)acrylate copolymer particle dispersion A, except that the above components were used instead.

The styrene-alkyl(meth)acrylate copolymer H had a glass transition temperature of 57° C. and a weight-average molecular weight Mw of 56,000.

### Preparation of Colorant Particle Dispersion

Carbon black: 250 parts (“Regal330” produced by Cabot Corporation)

Anionic surfactant: 33 parts (8% of the amount of colorant in terms of active ingredient, “Neogen SC” produced by DKS Co. Ltd. [active ingredient: 60%])

Ion-exchange water: 750 parts

Into a stainless steel container having a size such that, when all the above components are charged into the container, the level of the liquid surface reaches about 1/3 of the height of the container, a portion (280 parts) of the ion-exchange water and 33 parts of the anionic surfactant were charged. After the surfactant was dissolved to a sufficient degree, the whole amount of the solid solution pigment was added to the container. The resulting mixture was stirred using a stirrer until all the pigment particles became wet, and degassing was performed to a sufficient degree. After degassing was completed, the remaining portion of the ion-exchange water was added to the container, and dispersion was performed using a homogenizer (“ULTRA-TURRAX T50” produced by IKA) at 5,000 rpm for 10 minutes. Subsequently, stirring was performed with a stirrer the whole day to perform degassing. After degassing was completed, dispersion was again performed using the homogenizer at 6,000 rpm for 10 minutes. Subsequently, stirring was performed with a stirrer the whole day to perform degassing. The resulting dispersion was subjected to a high-pressure-impact-type disperser Ultimaizer (“HJP30006” produced by Sugino Machine Limited) at a pressure of 240 MPa in order to perform dispersion. Dispersion was performed to a level equivalent to 25 passes in consideration of the total amount of the dispersion charged and the capacity of the apparatus. The resulting dispersion was left standing for 72 hours to remove a precipitate. The solid content concentration in the dispersion was controlled to be 20% by adding ion-exchange water to the dispersion. Thus, a colorant particle dispersion was prepared.

### Preparation of Release-Agent Particle Dispersion

Polyethylene wax: 270 parts (hydrocarbon wax, product name “Polywax 725” produced by Baker Petrolite)

Anionic surfactant: 13.5 parts (3.0% of the amount of release agent in terms of active ingredient, “Neogen RK” produced by Dai-ichi Kogyo Seiyaku Co., Ltd. [active ingredient: 60%])

Ion-exchange water: 21.6 parts

The above components were mixed together, and the release agent was dissolved in the mixture using a pressure-discharge-type homogenizer (Gaulin homogenizer produced by Gaulin) at an inner-liquid temperature of 120° C. The resulting solution was subjected to dispersion at a dispersion pressure of 5 MPa for 120 minutes and subsequently subjected to further dispersion at 40 MPa for 360 minutes. The resulting dispersion was cooled to form a release-agent particle dispersion. The solid content concentration in the dispersion was controlled to be 20.0% by adding ion-exchange water to the dispersion.

### Example 1

### Preparation of Toner Particles (1)

Amorphous polyester resin particle dispersion A: 230 parts

Styrene-alkyl(meth)acrylate copolymer particle dispersion A: 44 parts

Crystalline polyester resin particle dispersion A: 25 parts

Colorant particle dispersion: 30 parts

Release-agent particle dispersion: 40 parts

Ion-exchange water: 150 parts

Anionic surfactant: 3 parts (“Dowfax2A1” produced by Dow Chemical Company)

The above components were charged into a 3-L reactor equipped with a thermometer, a pH-meter, and a stirrer. After the pH of the resulting mixture was changed to 4.0 by adding 1.0%-nitric acid to the mixture at 25° C., 18 parts of an aqueous aluminium sulfate solution was added to the mixture while dispersion was performed using a homogenizer (“ULTRA-TURRAX T50” produced by IKA Japan) at 5,000 rpm. Then, dispersion was performed for 3 minutes.

Subsequently, a stirrer and a heating mantle were attached to the reactor. The temperature was increased at a heating rate of 0.2 ° C./min until the temperature reached 40° C. and at a heating rate of 0.05 ° C./min after the temperature exceeded 40° C. while the number of rotation of the stirrer was controlled such that the slurry was stirred to a sufficient degree. During heating, the diameter of the resulting resin particles was measured every 10 minutes using “Multisizer II” (aperture diameter: 50 μm, produced by Coulter). When the volume-average diameter of the resin particles reached 5.4 μm, the temperature was kept constant and 100 parts of the amorphous polyester resin particle dispersion A was added to the reactor over 3 minutes.

After the temperature was kept constant for 30 minutes, the pH of the mixture was controlled to be 8.5 using a 10-aqueous sodium hydroxide solution. Subsequently, the mixture was heated to 90° C. at a heating rate of 1 ° C./min while the pH of the mixture was maintained to be 8.5 at intervals of 10° C. in the above-described manner. Then, the temperature of the mixture was kept constant. Observation of the shape and surfaces of the particles using an optical microscope and an electron scanning microscope (FE-SEM) confirmed that coalescence of the particles occurred after 4 hours. Then, the container was cooled to 35° C. over 5 minutes using cooling water.

The cooled slurry was passed through a nylon mesh having a sieve opening of 15 μm in order to remove coarse powder particles. The slurry containing toner particles that passed through the mesh was filtered using an aspirator under a reduced pressure. Toner particles that remained on the filter paper were pulverized manually such that the size of the toner particles was reduced to the minimum, and the pulverized toner particles were added to ion-exchange water of an amount ten times the amount of toner particles at 30° C. The resulting mixture was stirred for 30 minutes. Subsequently, the mixture was filtered using the aspirator under a reduced pressure. Toner particles that remained on a filter paper were pulverized manually such that the size of the toner particles was reduced to the minimum, and the pulverized toner particles were added to ion-exchange water of an amount ten times the amount of toner particles at 30° C. The resulting mixture was stirred for 30 minutes. The mixture was again filtered using the aspirator under a reduced pressure, and the electric conductivity of the resulting filtrate was measured. The above-described operation was repeated until the electric conductivity of the filtrate reached 10 μS/cm or less to clean the toner particles.

The cleaned toner particles were finely pulverized using a wet-dry granulator (Comil) and subsequently dried in vacuum in an oven kept at 35° C. for 40 hours. Thus, toner particles (1) were prepared.

The toner particles (1) had a volume-average diameter D50v of 6.3 μm.

### Preparation of Toner (1)

Toner particles (1): 100 parts

Silica particles: 0.8 parts (product name “RY50” produced by NIPPON AEROSIL CO., LTD.)

The above components were mixed together using a Henschel mixer at a peripheral speed of 20 m/s for 15 minutes. Thus, a toner (1) was prepared.

### Preparation of Carrier

Styrene-methyl methacrylate copolymer: 5 parts (mass ratio [styrene/methyl methacrylate]: 70/30)

Toluene: 15 parts

Carbon black: 1 part (“Regal330” produced by Cabot Corporation)

The above components were mixed together, and the resulting mixture was stirred for 10 minutes with a stirrer. Thus, a coating-layer forming solution was prepared. The coating-layer forming solution and 100 parts of ferrite particles (volume-average particle diameter: 40 μm) were charged into a vacuum-degassing-type kneader, and the resulting mixture was stirred at 60° C. for 30 minutes. Subsequently, degassing was performed under a reduced pressure while the temperature was increased. Then, drying was performed. Thus, a carrier was prepared.

### Preparation of Developer (1)

Using a V-blender, 8 parts of the toner (1) was mixed with 92 parts of the carrier to prepare a developer (1).

### Examples 2 to 4 and 7 to 12 and Comparative Examples 1 and 2

Toner particles (2) to (4) and (7) to (14), toners (2) to (4) and (7) to (14), and developers (2) to (4) and (7) to (14) were prepared as in Example 1, except that the types and numbers of parts (i.e., amounts charged) of the amorphous polyester resin particle dispersion, the styrene-alkyl(meth)acrylate copolymer particle dispersion, and the crystalline polyester resin particle dispersion were changed as described in Table 1.

### Example 5

Amorphous polyester resin particle dispersion A: 200 parts

Styrene-alkyl(meth)acrylate copolymer particle dispersion A: 44 parts

Crystalline polyester resin particle dispersion A: 25 parts

Colorant particle dispersion: 30 parts

Release-agent particle dispersion: 40 parts

Ion-exchange water: 150 parts

Anionic surfactant: 3 parts (“Dowfax2A1” produced by Dow Chemical Company)

The above components were charged into a 3-L reactor equipped with a thermometer, a pH-meter, and a stirrer. After the pH of the resulting mixture was changed to 4.0 by adding 1.0%-nitric acid to the mixture at 25° C., 18 parts of an aqueous aluminium sulfate solution was added to the mixture while dispersion was performed using a homogenizer (“ULTRA-TURRAX T50” produced by IKA Japan) at 5,000 rpm. Then, dispersion was performed for 3 minutes.

Subsequently, a stirrer and a heating mantle were attached to the reactor. The temperature was increased at a heating rate of 0.2 ° C./min until the temperature reached 40° C. and at a heating rate of 0.05 ° C./min after the temperature exceeded 40° C. while the number of rotation of the stirrer was controlled such that the slurry was stirred to a sufficient degree. During heating, the diameter of the resulting resin particles was measured every 10 minutes using “Multisizer II” (aperture diameter: 50 μm, produced by Coulter). When the volume-average diameter of the resin particles reached 5.4 μm, the temperature was kept constant and 350 parts of the amorphous polyester resin particle dispersion A was added to the reactor over 3 minutes.

After the temperature was kept constant for 30 minutes, the pH of the mixture was controlled to be 8.5 using a 10-aqueous sodium hydroxide solution. Subsequently, the mixture was heated to 90° C. at a heating rate of 1 ° C./min while the pH of the mixture was maintained to be 8.5 at intervals of 10° C. in the above-described manner. Then, the temperature of the mixture was kept constant. Observation of the shape and surfaces of the particles using an optical microscope and an electron scanning microscope (FE-SEM) confirmed that coalescence of the particles occurred after 4 hours. Then, the container was cooled to 35° C. over 5 minutes using cooling water.

The cooled slurry was passed through a nylon mesh having a sieve opening of 15 μm in order to remove coarse powder particles. The slurry containing toner particles that passed through the mesh was filtered using an aspirator under a reduced pressure. Toner particles that remained on the filter paper were pulverized manually such that the size of the toner particles was reduced to the minimum, and the pulverized toner particles were added to ion-exchange water of an amount ten times the amount of toner particles at 30° C. The resulting mixture was stirred for 30 minutes. Subsequently, the mixture was filtered using the aspirator under a reduced pressure. Toner particles that remained on a filter paper were pulverized manually such that the size of the toner particles was reduced to the minimum, and the pulverized toner particles were added to ion-exchange water of an amount ten times the amount of toner particles at 30° C. The resulting mixture was stirred for 30 minutes. The mixture was again filtered using the aspirator under a reduced pressure, and the electric conductivity of the resulting filtrate was measured. The above-described operation was repeated until the electric conductivity of the filtrate reached 10 μS/cm or less to clean the toner particles.

The cleaned toner particles were finely pulverized using a wet-dry granulator (Comil) and subsequently dried in vacuum in an oven kept at 35° C. for 40 hours. Thus, toner particles (5) were prepared.

The toner particles (5) had a volume-average diameter D50v of 6.3 μm.

Toner (5) and developer (5) were prepared as in Example 1, except that the toner particles (5) were used instead.

### Example 6

Amorphous polyester resin particle dispersion A: 250 parts

Styrene-alkyl(meth)acrylate copolymer particle dispersion A: 44 parts

Crystalline polyester resin particle dispersion A: 25 parts

Colorant particle dispersion: 30 parts

Release-agent particle dispersion: 40 parts

Ion-exchange water: 150 parts

Anionic surfactant: 3 parts (“Dowfax2A1” produced by Dow Chemical Company)

The above components were charged into a 3-L reactor equipped with a thermometer, a pH-meter, and a stirrer. After the pH of the resulting mixture was changed to 4.0 by adding 1.0%-nitric acid to the mixture at 25° C., 18 parts of an aqueous aluminium sulfate solution was added to the mixture while dispersion was performed using a homogenizer (“ULTRA-TURRAX T50” produced by IKA Japan) at 5,000 rpm. Then, dispersion was performed for 3 minutes.

Subsequently, a stirrer and a heating mantle were attached to the reactor. The temperature was increased at a heating rate of 0.2 ° C./min until the temperature reached 40° C. and at a heating rate of 0.05 ° C./min after the temperature exceeded 40° C. while the number of rotation of the stirrer was controlled such that the slurry was stirred to a sufficient degree. During heating, the diameter of the resulting resin particles was measured every 10 minutes using “Multisizer II” (aperture diameter: 50 μm, produced by Coulter). When the volume-average diameter of the resin particles reached 5.4 μm, the temperature was kept constant and 50 parts of the amorphous polyester resin particle dispersion A was added to the reactor over 3 minutes.

After the temperature was kept constant for 30 minutes, the pH of the mixture was controlled to be 8.5 using a 10-aqueous sodium hydroxide solution. Subsequently, the mixture was heated to 90° C. at a heating rate of 1 ° C./min while the pH of the mixture was maintained to be 8.5 at intervals of 10° C. in the above-described manner. Then, the temperature of the mixture was kept constant. Observation of the shape and surfaces of the particles using an optical microscope and an electron scanning microscope (FE-SEM) confirmed that coalescence of the particles occurred after 4 hours. Then, the container was cooled to 35° C. over 5 minutes using cooling water.

The cooled slurry was passed through a nylon mesh having a sieve opening of 15 μm in order to remove coarse powder particles. The slurry containing toner particles that passed through the mesh was filtered using an aspirator under a reduced pressure. Toner particles that remained on the filter paper were pulverized manually such that the size of the toner particles was reduced to the minimum, and the pulverized toner particles were added to ion-exchange water of an amount ten times the amount of toner particles at 30° C. The resulting mixture was stirred for 30 minutes. Subsequently, the mixture was filtered using the aspirator under a reduced pressure. Toner particles that remained on a filter paper were pulverized manually such that the size of the toner particles was reduced to the minimum, and the pulverized toner particles were added to ion-exchange water of an amount ten times the amount of toner particles at 30° C. The resulting mixture was stirred for 30 minutes. The mixture was again filtered using the aspirator under a reduced pressure, and the electric conductivity of the resulting filtrate was measured. The above-described operation was repeated until the electric conductivity of the filtrate reached 10 μS/cm or less to clean the toner particles.

The cleaned toner particles were finely pulverized using a wet-dry granulator (Comil) and subsequently dried in vacuum in an oven kept at 35° C. for 40 hours. Thus, toner particles (6) were prepared.

The toner particles (6) had a volume-average diameter D50v of 6.3 μm.

Toner (6) and developer (6) were prepared as in Example 1, except that the toner particles (6) were used instead.

### Comparative Example 3

Toner particles (15) were prepared as in Example 1, except that the types and numbers of parts (i.e., amounts charged) of the amorphous polyester resin particle dispersion, the styrene-alkyl(meth)acrylate copolymer particle dispersion, and the crystalline polyester resin particle dispersion were changed as described in Table 1. A toner (15) and a developer (15) were prepared as in Example 1, except that 0.8 parts of styrene-butyl acrylate copolymer particles (glass transition temperature: 57° C., molecular weight: 56,000) were used as a surface additive in combination with the silica particles.

### Evaluations

### Proportion of Styrene-Alkyl(Meth)Acrylate Copolymer in Resin Components Deposited on Toner Particle Surfaces

The proportion of the styrene-alkyl(meth)acrylate copolymer in resin components deposited on the surfaces of the toner particles was determined by the above-described method.

### Content of Specific Low-Molecular-Weight Components

The content of the specific low-molecular-weight components in resin components of the toner was determined by the above-described method.

### Evaluation of Image Loss Due to Document Offset

The developers prepared in Examples and Comparative Examples were each charged into a developing device of a production printer “D136 Light Publisher” produced by Fuji Xerox Co., Ltd.

Using this image forming apparatus, a halftone image (image density: 50%) was formed on the entirety of one surface of each of 100 OHP films (produced by Fuji Xerox Co., Ltd.) under a high-temperature, high-humidity condition (temperature: 30° C., humidity: 85RH %). The OHP films containing images formed thereon were stacked on one another. After the OHP films were left standing for 30 minutes, the first OHP film was removed such that the surface of the first OHP film on which an image was formed was detached from the surface of the second OHP film on which an image was not formed. The surface of the first OHP film on which an image was formed was evaluated for image loss due to document offset in accordance with the following criteria. Table 2 summarizes the results.

### Evaluation Criteria

G0: Image loss did not occur.

G1: The number of blank dots at which part of the image was detached (i.e., image loss) was less than 5.

G2: The number of blank dots at which part of the image was detached (i.e., image loss) was 5 or more and less than 10.

G3: The number of blank dots at which part of the image was detached (i.e., image loss) was 10 or more.

### Evaluation of Low-Temperature Fixability

The electrostatic-image developers prepared in Examples and Comparative Examples were each charged into a developing device of a color copier DocuCentreColor400 (produced by Fuji Xerox Co., Ltd.) from which a fixing device had been detached. Then, 50 mm×50 mm unfixed images were each formed on one surface of an OHP film, that is, a recording medium, at an area coverage of 100% while the amount of toner deposited on the image was controlled to be 0.45 mg/cm². The fixation evaluation apparatus used was prepared by creating a fixing device detached from an “ApeosPortIV C3370” (produced by Fuji Xerox Co., Ltd.) to allow the fixing temperature to be changed. The fixing device had a nip width of 6 mm, a nip pressure of 1.6 kgf/cm², a dwell time of 34.7 ms, and a processing speed of 175 mm/sec. The unfixed images were fixed to the OHP films at various fixing temperatures increasing from 100° C. at intervals of 5° C. The fixed images were visually inspected for the presence or absence of cold offset, and the temperature at which cold offset disappeared was considered to be the cold-offset disappearing temperature. Evaluation of low-temperature fixability was made on the basis of this index. Table 2 summarizes the results.

### Evaluation Criteria

G0: Cold-offset disappearing temperature was 145° C. or less.

G1: Cold-offset disappearing temperature was more than 145° C. and 150° C. or less.

G2: Cold-offset disappearing temperature was more than 150° C. and 160° C. or less.

G3: Cold-offset disappearing temperature was more than 160° C.

TABLE 1

| | | | Amorphous | | | | | | | | | | |
|---|---|---|---|---|---|---|---|---|---|---|---|---|---|
| | | | polyester resin | | | Styrene-alkyl(meth)acrylate copolymer | | | | | Crystalline polyester resin | | |
| | | Devel- | | Particle | | Molecular | | Particle | | Carbon | Particle | | Carbon number |
| | Toner | oper | Tg(B) | dispersion | | weight | Tg(A) | dispersion | | number of | dispersion | | of aliphatic |
| | No. | No. | ° C. | Type | Parts | (Mw) | ° C. | Type | Parts | alkyl ester | Type | Parts | component |
| Example 1 | 1 | 1 | 57 | A | 330 | 56000 | 57 | A | 44 | 4 | A | 25 | 6 |
| Example 2 | 2 | 2 | 57 | D | 330 | 56000 | 57 | A | 44 | 4 | A | 25 | 6 |
| Example 3 | 3 | 3 | 57 | A | 330 | 56000 | 59.5 | B | 44 | 4 | A | 25 | 6 |
| Example 4 | 4 | 4 | 55 | B | 330 | 56000 | 45 | C | 44 | 4 | A | 25 | 6 |
| Example 5 | 5 | 5 | 57 | A | 550 | 56000 | 57 | A | 44 | 4 | A | 25 | 6 |
| Example 6 | 6 | 6 | 57 | A | 300 | 56000 | 57 | A | 44 | 4 | A | 25 | 6 |
| Example 7 | 7 | 7 | 57 | A | 330 | 56000 | 57 | A | 44 | 4 | A | 25 | 6 |
| Example 8 | 8 | 8 | 57 | A | 330 | 56000 | 57 | A | 44 | 4 | A | 25 | 6 |
| Example 9 | 9 | 9 | 57 | A | 330 | 65000 | 57 | F | 44 | 4 | A | 25 | 6 |
| Example 10 | 10 | 10 | 57 | A | 330 | 40000 | 57 | G | 44 | 4 | A | 25 | 6 |
| Example 11 | 11 | 11 | 57 | A | 330 | 56000 | 57 | H | 44 | 2 | B | 25 | 14 |
| Example 12 | 12 | 12 | 57 | E | 330 | 56000 | 57 | A | 44 | 4 | A | 25 | 6 |
| Comparative | 13 | 13 | 58 | C | 330 | 56000 | 61 | D | 44 | 4 | A | 25 | 6 |
| example 1 | | | | | | | | | | | | | |
| Comparative | 14 | 14 | 55 | B | 330 | 56000 | 44 | E | 44 | 4 | A | 25 | 6 |
| example 2 | | | | | | | | | | | | | |
| Comparative | 15 | 15 | 57 | A | 330 | — | — | — | 0 (as | — | A | 25 | 6 |
| example 3 | | | | | | | | | surface | | | | |
| | | | | | | | | | additive) | | | | |

TABLE 2

| | | | | | | | | Content of | | | |
|---|---|---|---|---|---|---|---|---|---|---|---|
| | | | | Styrene-alkyl(meth)acrylate copolymer | | | | specific low- | | | |
| | | De- | | Proportion on | | | | molecular | | | |
| | | vel- | | toner particle | | | | weight | | Low-temperature | |
| | Toner | oper | ΔTg | surfaces | Content | | ΔCarbon | components | Image loss | fixability | |
| | No. | No. | (° C.) | (%) | (mass %) | Addition method | number | (%) | Evaluation | Evaluation | Temperature |
| Example 1 | 1 | 1 | 0 | 12 | 20 | As internal additive | 2 | 2 | G0 | G0 | 145 |
| Example 2 | 2 | 2 | 0 | 12 | 20 | As internal additive | 2 | 8 | G2 | G1 | 150 |
| Example 3 | 3 | 3 | 2.5 | 12 | 20 | As internal additive | 2 | 2 | G2 | G2 | 155 |
| Example 4 | 4 | 4 | 10 | 12 | 20 | As internal additive | 2 | 2 | G1 | G2 | 155 |
| Example 5 | 5 | 5 | 0 | 20 | 20 | As internal additive | 2 | 2 | G0 | G1 | 150 |
| Example 6 | 6 | 6 | 0 | 5 | 20 | As internal additive | 2 | 2 | G2 | G1 | 150 |
| Example 7 | 7 | 7 | 0 | 20 | 30 | As internal additive | 2 | 2 | G0 | G1 | 150 |
| Example 8 | 8 | 8 | 0 | 6 | 5 | As internal additive | 2 | 2 | G2 | G1 | 150 |
| Example 9 | 9 | 9 | 0 | 12 | 20 | As internal additive | 2 | 2 | G1 | G0 | 145 |
| Example 10 | 10 | 10 | 0 | 12 | 20 | As internal additive | 2 | 2 | G2 | G1 | 150 |
| Example 11 | 11 | 11 | 0 | 12 | 20 | As internal additive | 12 | 2 | G2 | G2 | 155 |
| Example 12 | 12 | 12 | 0 | 12 | 20 | As internal additive | 2 | 10 | G2 | G1 | 150 |
| Comparative | 13 | 13 | 3 | 12 | 20 | As internal additive | 2 | 2 | G3 | G2 | 160 |
| example 1 | | | | | | | | | | | |
| Comparative | 14 | 14 | 11 | 11 | 20 | As internal additive | 2 | 2 | G3 | G3 | 165 |
| example 2 | | | | | | | | | | | |
| Comparative | 15 | 15 | 0 | 12 | 0 | As surface additive | 2 | 2 | G3 | G2 | 155 |
| example 3 | | | | | | | | | | | |

In Table 2, “ATg” refers to the absolute value of the difference between the glass transition temperature Tg(B) of the amorphous polyester resin and the glass transition temperature Tg(A) of the styrene-alkyl(meth)acrylate copolymer;

“Content” of “Styrene-alkyl(meth)acrylate copolymer” refers to the content of the styrene-alkyl(meth)acrylate copolymer in the toner particles;

“Proportion on toner particle surfaces” refers to the proportion of the styrene-alkyl(meth)acrylate copolymer in resin components deposited on the surfaces of the toner particles which was determined by XPS; and

“ΔCarbon number ” refers to the absolute value of the difference between the number of carbon atoms included in an alkyl group of the (meth)acrylate constituting the styrene-alkyl(meth)acrylate copolymer and the smaller of the numbers of carbon atoms included in alkylene groups of the saturated aliphatic dicarboxylic acid and the saturated aliphatic diol constituting the crystalline polyester resin.

In the above-described results, higher ratings are given to Examples in terms of “Image loss” and “Low-temperature fixability” than to Comparative Examples. This confirms that, in Examples, the likelihood of image loss due to document offset which might occur when films (i.e., recording media) having low-temperature fixability and containing images formed thereon were stacked on one another was reduced compared with Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic-image developing toner including a toner particle comprising:
a binder resin including an amorphous polyester resin and a crystalline polyester resin; and
a styrene-alkyl(meth)acrylate copolymer,
a glass transition temperature Tg(A) of the styrene-alkyl(meth)acrylate copolymer and a glass transition temperature Tg(B) of the amorphous polyester resin satisfying Relational expression (1) below.
Tg(B)−10≦Tg(A)≦Tg(B)+2.5 (1)

2. The electrostatic-image developing toner according to claim 1,
wherein a proportion of a component having a molecular weight of 1,000 or more and 2,000 or less in a molecular weight distribution of the toner, the molecular weight distribution being measured by gel permeation chromatography, is 8% or less.

3. The electrostatic-image developing toner according to claim 1,
wherein a proportion of the styrene-alkyl(meth)acrylate copolymer in a resin component deposited on a surface of the toner particle is 5 atom % or more and 20 atom % or less as determined by X-ray photoelectron spectroscopy (XPS).

4. The electrostatic-image developing toner according to claim 1,
wherein a content of the styrene-alkyl(meth)acrylate copolymer in the toner particle is 10% by mass or more and 30% by mass or less.

5. The electrostatic-image developing toner according to claim 1,
wherein the styrene-alkyl(meth)acrylate copolymer has a weight-average molecular weight Mw of 40,000 or more and 65,000 or less.

6. The electrostatic-image developing toner according to claim 1,
wherein the styrene-alkyl(meth)acrylate copolymer includes an alkyl (meth)acrylate including an alkyl group having 2 to 8 carbon atoms, a proportion of the alkyl (meth)acrylate in all monomer components of the styrene-alkyl(meth)acrylate copolymer being 20% by mass or more, and
wherein the crystalline polyester resin includes at least one monomer selected from a saturated aliphatic polyhydric alcohol including an alkylene group having 6 to 14 carbon atoms and a saturated aliphatic polyvalent carboxylic acid including an alkylene group having 6 to 14 carbon atoms, a proportion of the at least one monomer in all monomer components of the crystalline polyester resin being 30% by mass or more.

7. The electrostatic-image developing toner according to claim 1,
wherein the styrene-alkyl(meth)acrylate copolymer has a glass transition temperature Tg(A) of 40° C. or more and 70° C. or less.

8. The electrostatic-image developing toner according to claim 1,
wherein a content of the styrene-alkyl(meth)acrylate copolymer in the toner particle is 5% by mass or more and 30% by mass or less.

9. The electrostatic-image developing toner according to claim 1,
wherein the amorphous polyester resin has a glass transition temperature Tg(B) of 50° C. or more and 80° C. or less.

10. The electrostatic-image developing toner according to claim 1,
wherein the amorphous polyester resin has a weight-average molecular weight Mw of 5,000 or more and 1,000,000 or less.

11. The electrostatic-image developing toner according to claim 1,
wherein the amorphous polyester resin has a number-average molecular weight Mn of 2,000 or more and 100,000 or less.

12. The electrostatic-image developing toner according to claim 1,
wherein the amorphous polyester resin has a molecular weight distribution index Mw/Mn of 1.5 or more and 100 or less.

13. The electrostatic-image developing toner according to claim 1,
wherein the crystalline polyester resin has a melting temperature of 50° C. or more and 100° C. or less.

14. The electrostatic-image developing toner according to claim 1,
wherein the crystalline polyester resin has a weight-average molecular weight Mw of 6,000 or more and 35,000 or less.

15. The electrostatic-image developing toner according to claim 1,
wherein all monomer components of the crystalline polyester resin include a saturated aliphatic polyvalent carboxylic acid including an alkylene group having 6 to 14 carbon atoms and a saturated aliphatic polyhydric alcohol including an alkylene group having 6 to 14 carbon atoms.

16. The electrostatic-image developing toner according to claim 1,
wherein a content of the binder resin in the toner particle is 40% by mass or more and 95% by mass or less.

17. The electrostatic-image developing toner according to claim 1,
wherein the toner particle further comprises a release agent.

18. The electrostatic-image developing toner according to claim 17,
wherein the release agent has a melting temperature of 50° C. or more and 110° C. or less.

19. An electrostatic-image developer comprising the electrostatic-image developing toner according to claim 1.

20. A toner cartridge comprising the electrostatic-image developing toner according to claim 1, the toner cartridge being detachably attachable to an image forming apparatus.
